(19) United States
(12) Patent Application Publication
(10) Pub. No.: US 2021/0241230 A1
(43) Pub. Date: Aug. 5, 2021

(54) SYSTEM AND METHOD FOR CONSUMER SERVICES MARKETPLACE

(71) Applicant: TULBELT, LLC, ALLSTON, MA (US)

(72) Inventors: JAN VEZIKOV, BROOKLINE, MA (US); VLADIMIR VEZIKOV, JR., ALLSTON, MA (US)

(21) Appl. No.: 16/777,325

(22) Filed: Jan. 30, 2020

(51) Int. Cl. G06Q 10/10; G06Q 30/08; G06Q 30/06; G06Q 20/40; G06Q 30/02; G06Q 50/16; H04W 4/029

(52) U.S. Cl. CPC G06Q 10/103; G06Q 30/08; G06Q 30/0611; H04W 4/029; G06Q 30/0282; G06Q 50/165; G06Q 20/405

(57) ABSTRACT

A system may include memory, a networking interface, and a processing system including at least one processor communicably coupled to the memory and the networking interface. The processing system may be configured to: receive project information from a client device associated with a client, the project information including at least one image and a description of a project related to a physical location; receive bid information for the project proposal from the plurality of devices associated with professionals; receive, from the client device, instructions to accept one of the plurality of bids; receive, from the client device and/or the device associated with the professional whose bid is accepted, information about one or more milestones for the project; and authorize transmission of payment for the project to the professional after receiving a confirmation of project completion from the client device and the device associated with the professional whose bid is accepted.

### FIELD

The field of the exemplary embodiments of this application relates to systems and methods for a consumer services marketplace and more particularly to a platform for listing, bidding on, and/or managing completion and payment of services, particularly home services.

### BACKGROUND

The present disclosure addresses a variety of problems that are encountered in the context of providing a consumer services marketplace. The information provided below is not admitted to be prior art, but is provided solely to assist the understanding of the reader.

Professionals, such as plumbers, electricians, carpenters, landscapers, movers, cleaners, and painters, advertise their services with an invitation to provide a free estimate. While the estimate may be free for the consumer (e.g., customer), providing an estimate does not come without cost to the professional. Providing an estimate can take hours, depending on the size and scope of the project. The professional spends time driving to the location of the project, inspecting and taking measurements of the work to be performed, preparing and presenting an estimate, and returning from the location of the project. After investing all this time to provide the estimate, there is a possibility that the professional will not even be selected for the project.

The hours needed to provide free estimates could be more effectively spent by actually working on a project. At least for this reason, some larger companies employ full time personnel whose only job is to provide estimates. However, not everyone can devote resources to a full-time estimate provider.

To hire the most qualified professional for the project and/or receive the best cost estimate, consumers will typically ask several professionals to provide written estimates for a project. This process includes finding potential professionals, making an appointment with each potential professional, being available for the appointment to explain the project and provide access to the project location, comparing the received estimates and negotiating any changes to the selected estimate. Due to the effort needed to receive the estimates, consumers typically will limit themselves to only a couple of estimates and in many cases will select the first estimate if it seems to be reasonable. Placing limits on the number of estimates may cause the consumer to overpay and/or receive lower quality results.

In addition to the challenges in obtaining an estimate for a project, there are also challenges faced by the consumers and professionals in negotiating and signing a contract, making payments, satisfying unhappy customers, dealing with poor job performance and/or rating consumers and professionals. Moreover, as of now, most readily available rating platforms are one-sided, with professionals being rated, and no such information provided on the customers.

### SUMMARY

These and other objects are met by the system and method disclosed herein that provides a system and/or method for a consumer services marketplace in which a customer and professional can obtain estimates, negotiate and agree on a contract, transfer payments, address unhappy consumers and/or poor job performance, and/or rate customers and/or professionals.

The systems and methods can provide a platform for listing and bidding on home improvement and home maintenance work. The platform may utilize industry best practices for peer-to-peer marketplaces, such as a lister-Professional rating system and live scheduling.

According to examples of the present technology, a system may include memory, a networking interface, and a processing system including at least one processor communicably coupled to the memory and the networking interface. The processing system may be configured to: receive project information from a client device associated with a customer, the project information including at least one image and a description of a project related to a physical location; receive bid information for the project proposal from the plurality of devices associated with professionals; receive, from the client device, instructions to accept one of the plurality of bids; receive, from the client device and/or the device associated with the professional whose bid is accepted, information about one or more milestones for the project; and authorize transmission of payment for the project to the professional after receiving a confirmation of project completion from the client device and the device associated with the professional whose bid is accepted.

According to another example of the present technology, a system may include memory, a networking interface, a processing system including at least one processor communicably coupled to the memory and the networking interface. The processing system may be configured to at least: receive project information from a client device associated with a client, the project information including at least one image and a description of a project related to a physical location; generate, based on the received project information, a project proposal; transmit information about the project proposal to a plurality of devices each associated with a respective professional; in response to transmitting the project proposal, receive bid information for the project proposal from the plurality of devices associated with the professionals; transmit information for a plurality of bids for the project received from the plurality of devices associated with the professionals to the client device; receive, from the client device, instructions to accept one of the plurality of bids; receive, from the client device and/or the device associated with the professional whose bid is accepted, information about one or more milestones for the project; and authorize transmission of payment for the project to the professional after receiving a confirmation of project completion from the client device and the device associated with the professional whose bid is accepted.

According to another example of the present technology, a system may include memory, a networking interface, a processing system including at least one processor communicably coupled to the memory and the networking interface. The processing system may be configured to at least: receive project information from a client device associated with a client, the project information including at least one image and a description of a project related to a physical location; generate, based on the received project information, a project proposal; transmit information about the project proposal to a plurality of professional devices each associated with a respective professional; in response to transmitting the project proposal, receive bid information for the project proposal from the plurality of devices associated with the professionals, the bid information including a cost for completing the project; when the cost for completing the project is above a pre-set threshold, receiving information about at least one milestone from the corresponding professional device; transmit information for a plurality of bids for the project received from the plurality of devices associated with the professionals to the client device; receive, from the client device, instructions to accept one of the plurality of bids; after receiving the instructions to accept the one of the plurality of bids, receive, from the client device, payment information for the cost of completing the project for the accepted bid; and when the accepted bid includes at least one milestone, (1) authorize transmission of a portion of the cost of completing the project to the professional after receiving a confirmation for completing the at least one milestone from the client device and the professional device associated with the professional whose bid is accepted and (2) authorize transmission of another portion of the cost of completing the project to the professional after receiving a confirmation for completing the project from the client device and the professional device associated with the professional whose bid is accepted.

According to another example of the present technology, non-transitory storage medium may store computer-readable instructions executable by a computer including at least one processor, the instructions, when executed by the computer, cause the computer to at least: receive project information from a client device associated with a client, the project information including at least one image and a description of a project related to a physical location; generate, based on the received project information, a project proposal; transmit information about the project proposal to a plurality of devices each associated with a respective professional; in response to transmitting the project proposal, receive bid information for the project proposal from the plurality of devices associated with the professionals; transmit information for a plurality of bids for the project received from the plurality of devices associated with the professionals to the client device; receive, from the client device, instructions to accept one of the plurality of bids; receive, from the client device and/or the device associated with the professional whose bid is accepted, information about one or more milestones for the project; and authorize transmission of payment for the project to the professional after receiving a confirmation of project completion from the client device and the device associated with the professional whose bid is accepted.

According to another example of the present technology, a device associated with a client may display a user interface configured to: receive project information including at least one image and a description of a project related to a physical location, display a plurality of bids for the project, receive an input indicating selection of one of the plurality of bids, receive payment information for the selected bid, confirm completion of one or more milestones and/or completion of the project.

According to another example of the present technology, a device associated with a professional may display a user interface configured to: display one or more projects matching criteria set by the professional; receive input selecting a project; receiving bid information for the selected project, the bid information including at least one milestone for the project; indicating acceptance of the bid by the client; receiving an input for competition of at least one milestone; and receiving an input for completion of the project.

According to another example of the present technology, a device may include a display, a networking interface, an input device and a processing system including at least one processor coupled to the display, the networking interface and the input device. The processing system may be configured to: receive, from an external processing system using the networking interface, information about a plurality of project proposals related to different physical locations; control the display to display a user interface including the information about each of the plurality of project proposals; receive a first user input from the input device selecting one of the plurality of project proposals; receive a second user input, indicating a bid and one or more milestones for the selected project proposal; transmit, to the external processing system, information about the bid and the one or more milestones.

According to another example of the present technology, a processing device may include a display device, a networking interface, an input device and a processing system including at least one processor coupled to the display, the networking interface and the input device. The processing system may be configured to: control the display device to display a user interface including (1) a project name for a project at a physical location, (2) at least one image for the project, (3) a plurality of bids for the project each corresponding to a different professional, wherein at least one of the plurality of bids includes a description for the bid and a plurality of selectable milestones, and (4) a selectable option to accept one of the plurality of bids; and in response to an input using the input device selecting one of the selectable milestones, control the display device to display a description of the selected milestone.

### BRIEF DESCRIPTION OF THE DRAWINGS

The following detailed description of exemplary non-limiting illustrative embodiments is to be read in conjunction with the drawings of which:

FIG. 1 illustrates a system that may be used by a client requesting a proposal for a project on a house according to an embodiment of the present technology;

FIG. 2 illustrates an information flow diagram between a client device, a central processing system, and a device associated with a professional according to an embodiment of the present technology;

FIG. 3 illustrates a proposal to project completion workflow according to an embodiment of the present disclosure;

FIG. 4 illustrates a project and payment flow according to an embodiment of the present disclosure;

FIG. 5 illustrates a proposal sourcing workflow according to an embodiment of the present disclosure;

FIG. 6A shows an example of a client dashboard that may be displayed on a display of a device according to an embodiment of the present technology;

FIG. 6B shows an example of a screen that can be displayed to create a new project proposal on a client device according to an embodiment of the present technology;

FIG. 6B-1 shows an example of a list of selectable service types according to an embodiment of the present technology;

FIG. 6B-2 shows an example of a calendar showing selectable dates for completion time of the project according to an embodiment of the present technology;

FIG. 6C shows an example screen that may be displayed to a professional for searching for proposals according to an embodiment of the present technology;

FIGS. 6D and 6E show example screens of a detailed view for a project according to an embodiment of the present technology;

FIGS. 6F and 6G show example screens for inputting a bid for a project according to an embodiment of the present technology;

FIGS. 6H and 6I show example screens providing bid information that may be displayed on a client device according to an embodiment of the present technology;

FIG. 6J shows an example of a screen that may be displayed when “details” is selected in the screen shown in FIG. 6I according to an embodiment of the present technology;

FIG. 7A shows a screen that may be displayed on a professional's device showing progress of a project according to an embodiment of the present technology;

FIG. 7B shows a screen that may be displayed when an input is received by the professional to submit the next milestone according to an embodiment of the present technology;

FIG. 7C shows an example screen that may be displayed on a client device showing the progress of the project and milestones according to an embodiment of the present technology;

FIG. 7D shows a milestone confirmation screen that may be displayed to a client on a client device according to an embodiment of the present technology;

FIG. 7E shows a completed project summary that may be displayed on a professional's device according to an embodiment of the present technology;

FIG. 8A shows an example of a professional's dashboard screen including a project feed according to an embodiment of the present technology;

FIG. 8B show a professional portfolio screen according to an embodiment of the present technology; and

FIG. 9 shows a block diagram of an example computing device according to an embodiment of the present technology.

### DETAILED DESCRIPTION OF EXAMPLE NON-LIMITING EMBODIMENTS

The example non-limiting technology herein provide a platform for listing and bidding on home improvement and home maintenance work. The platform may utilize industry best practices for peer-to-peer marketplaces, such as a Lister-Professional rating system and live scheduling.

The platform may include the following user archetypes: Homeowner (e.g., client), professional and system administrator. One of the core functions of the platform is to allow Homeowners to list work for Professionals to submit bids for. Once a bid is accepted, the Homeowner may submit payment into escrow accounts to be disbursed to the Professional, either as a lump sum upon completion (jobs under $1000) or in milestone-based intervals (jobs over $1000).

One or more milestones may be submitted by the Professional for review and negotiation by the Homeowner during the bidding process. Once a milestone has been achieved, the Professional may submit a request for confirmation to the homeowner. Once confirmed, a milestone payment may be disbursed to the Professional.

According to one embodiment, the platform may provide a payment processing, disbursement, and escrow in which:

a. Once a bid is accepted, the Homeowner will be prompted to immediately submit payment for the service into an escrow fund held by the platform service.

b. Payments will be disbursed to the Professional by the platform service, from the escrow fund, once both parties confirm completion of pre-determined milestones.

c. Payments and disbursements:
i. For accepted bids under a predetermined amount (e.g., under $1000), the entire payment is required and sent to escrow.
ii. For accepted bids over the predetermined amount (e.g., over $1000), milestones will be submitted during a bid by the Professional for review and negotiation.

d. If a Homeowner has credit (referral or otherwise), the credit will be applied and shown as a deduction prior to the payment.

e. After completion of a project, the Homeowner is prompted to tip the Professional if they feel so obliged.

According to one embodiment, the platform may provide a proposal generation, bidding, and finalization in which:

a. Homeowners will generate requests for proposals (Proposals) and Professionals will bid on those Proposals. Professionals will offer a schedule and milestones (if applicable) for Homeowners to review. Homeowners and Professionals can exchange communication to resolve questions or adjust scheduling.

b. Once a bid is accepted (after scheduling, milestones, and any adjustments to the bid have been finalized), the Homeowner will confirm the project to begin.

According to one embodiment, the platform may provide a favorite Professional status which:

a. After a Homeowner has a successful project with a Professional and provides the Professional with a predetermined rating (e.g., 4 out of 5 stars or higher rating), the Professional becomes a ‘Favorite Professional’ of the Homeowner.

b. Bidding as a Favorite Professional may provide a discount on platform fees for projects going forward.

According to one embodiment, the platform may provide dispute management which: a Homeowner may indicate dissatisfaction with completion of a portion or complete project.

According to one embodiment, the platform may manage notifications to the homeowner and/or professional, change personal information, manage payments using third-party payment processors for homeowners, and/or manage disbursements to bank accounts for professionals.

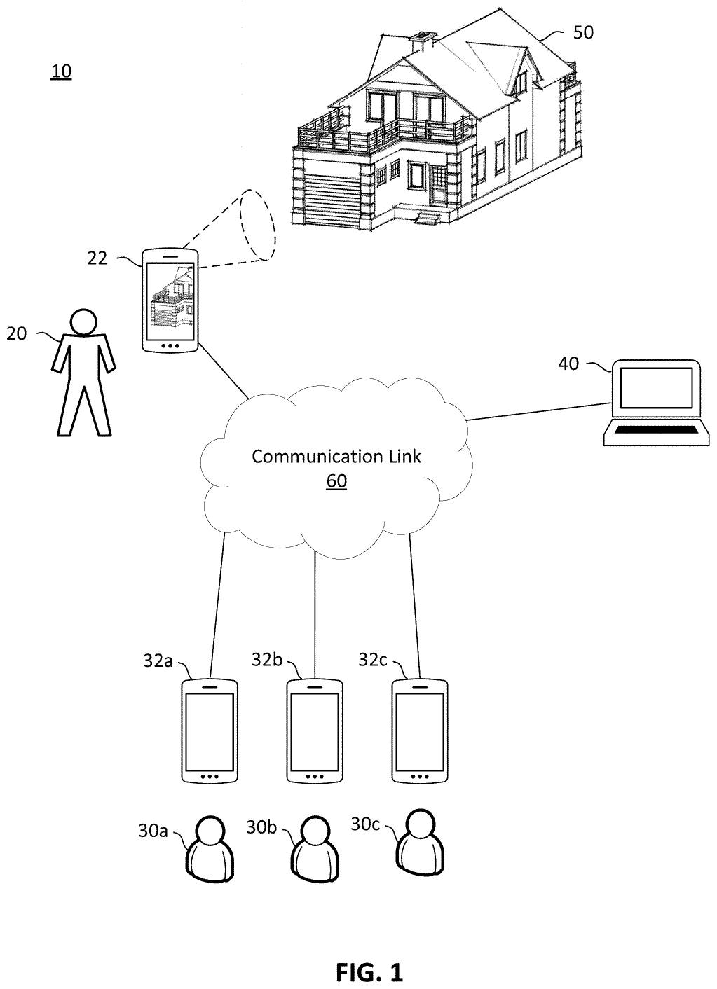

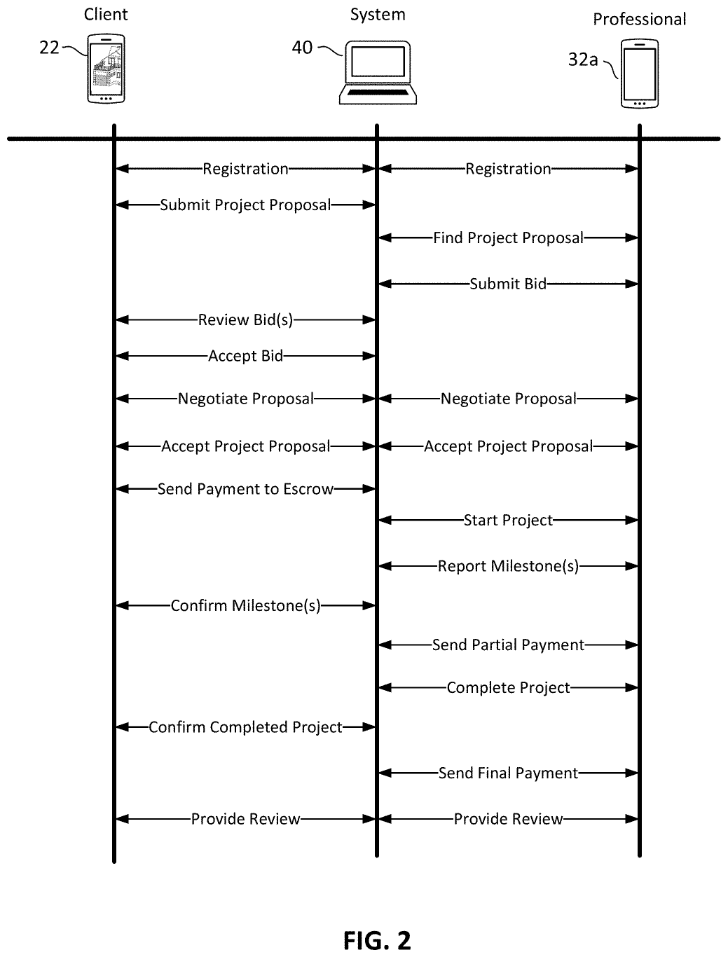

FIG. 1 illustrates a system 10 that may be used by a client 20 requesting a proposal for a project on a house 50 according to an embodiment of the present technology. The system 10 may allow the client 20 to create project proposals, receive project bids from one or more professionals 30a, 30b, and/or 30c, agree on a proposal, manage progress of project, pay for the project, and/or provide feedback and/or rating. FIG. 2 illustrates an information flow diagram between a client device 22, a central processing system 40, and a device 32a associated with a professional according to an embodiment of the present technology.

The client 20 may be an owner or tenant of the house 50. In some examples, the client 20 may be a representative of an insurance company obtaining cost estimates related to an insurance claim or a bank needing repair costs associated with a loan. The client 20 may use a device (e.g., a mobile device 22) to submit a project proposal including information about the project. Inputting the project proposal may include capturing one or more images and/or videos related to the project and providing a description of the project. As an example, the client 20 may capture a plurality of images or a video of a perimeter of the house 50 and input details of what portions of the house 50 need to be painted. The description of the project may include, for example, physical location (e.g., address), dimensions of a surface area to be painted, type of surface, color and/or type of paint, time frame for work to be performed, deadline for cost estimates, and/or qualifications of professional. The description of the project may include pictures, videos and/or links to projects of other properties (e.g., projects completed by a professional 30a, 30b or 30c) providing an example of desired outcome.

As will be discussed in more detail below, the system 10 may be configured to automatically extract certain information about the project based on one or more sensors (e.g., sensors in the mobile device 22) and/or the captured images and/or video of the project, and/or may automatically request certain additional information to be input by the client 20 based on analyzing the captured images and/or video of the project.

Requests for bids may be generated based on the project information. In one example, the requests may be generated by a central processing system 40. The central processing system 40 may include a server and/or a cloud computing platform (e.g., Amazon Web Services™, Google™ cloud platform, Microsoft™ Azure). In one form, the central processing system 40 is one or more computers; for example, a cluster of networked computers. In one form, the central processing system 40 may be one or more virtual computers, rather than physical computers.

The request may be provided to professionals (30a, 30b, and/or 30c) to submit cost estimates. In one example, the requests may be listed on a webpage displayed on the devices 32a, 32b, and/or 32c or in an application executing on the devices 32a, 32b, and/or 32c for the professional(s) to review and respond to the request. In another example, the request may be transmitted to one or more professionals 30a, 30b, and/or 30c satisfying one or more conditions. For example, based on the project information, the system may determine one or more professionals 30a, 30b, and/or 30c satisfying conditions of the project (e.g., rating of professional, qualifications, certifications and/or type of work performed by professional) and transmit a request for a cost estimate to the one or more professionals determined to satisfy one or more conditions. In some examples, the professional may use a search feature to find project proposals.

The devices 32a, 32b, and/or 32c may display the request and receive user input from the professionals 30a, 30b, and/or 30c providing a bid (e.g., a cost estimates for the project). The user input may include requesting additional information from the client 20, providing project specification (e.g., type of material that will be used), proposals to modify project requirements, project timing estimate, and/or cost estimate. In some examples, a single professional may provide a plurality of estimates, each providing a different conditions for the same project. For example, the different estimates provided by the same professional may provide different timing options (when project will be started and/or finished), different quality or type of materials to be used, and/or different modifications to the project.

The client 20 and one of the professionals 30a, 30b, and/or 30c may use their respective devices to modify, finalize and accept one of the proposals. Modifying and finalizing the proposal may include asking for specific information for the project, adjusting the proposal (e.g., adjust bid and submit proposed milestones and schedule), accepting or negotiating milestones and schedule, and/or submitting payment to escrow.

As shown in FIG. 2, the client device 22 may be used to review the one or more submitted bids and accept one of the bids. In some examples of the present technology, after accepting the bid, the client and/or the professional may negotiate specifics of the project proposal. For example, the client and the professional may agree on the type of materials that will be used, when the project will be started and/or completed, milestones and/or payment amount associated with each milestone, and total cost. After the negotiation is completed, the client and the professional may accept the modified project proposal.

In some examples, when the client accepts the initial proposal and/or after the proposal is modified, the client may be required to submit a payment (full or partial) for the project into escrow. In some examples, the client may provide a first payment (e.g., 50%) when the bid is tentatively accepted and the full amount after the final project proposal is accepted by the client.

The professional with the accepted proposal may provide updates on the project using the device. For example, the professional may indicate when the project will be or is started, capture images of the work progress, indicate when specified milestones are reached, and indicate completion of the project. In some examples, the professional may report milestones during the project phase. As will be discussed in more detail below, reporting milestones may include providing a description of the completed work and one or more images and/or videos of the completed work for review by the client.

After the professional reports completion of a milestone, the system 40 may request for the client to confirm the milestone completion. The client using the client device 22 may confirm completion of the milestone or request for additional work to be performed before completion of the milestone. After the system 40 receives an indication that the milestone is completed, the system 40 may transfer a partial payment from the escrow to the professional's account. The amount of the payment may be an amount associated with the milestone (e.g., an amount predetermined by the system or provided by the client and/or the professional).

After the project is completed, the system may receive an indication that the project is completed from the device 32a. The projection completion may include a description of the work performed and/or images and/or videos of the completed project. After a confirmation is received form the client device 22 that the project is completed, the final payment may be transferred from escrow to the professional's account.

After the project is completed, the system 40 may receive a review from the client device 22 on the work performed by the professional and/or a review from the device 32a about working with the client. The received reviews may be associated by the system 40 with profiles of the client and/or the professional.

In some examples of the present technology, the professional may add information about the completed project to a professional portfolio provided by the system 40. The professional portfolio may be reviewed by potential clients.

In some examples, the professional and/or the client may propose changes to the project after the project has started. For example, when a professional is painting a portion of a house he may discover additional repairs that need to be made that the professional and the client were not aware about. The professional may use the device 32a to indicate the additional repairs needed and propose a modification to the proposal (with or without a modification to the cost of the project). The client may have an option to accept or decline the proposed modification. Similarly, the client may propose a modification to the proposal and the professional may have an option to accept or decline the proposed modification.

As shown in FIG. 1, the professional(s) do not have to be at the physical location of the project (e.g., the location of the house 50) and/or with the client 20 to provide a bid for the requested project. Similarly, the client 20 does not have to be at the physical location of the project when the professional submits completion of a milestone or project and/or when the client confirms completion of the milestone or project.

The devices illustrated in FIGS. 1 and 2 may communicate over a communication link 60 comprising one or more networks. The communication link 60 may include one or more local communication networks and/or one or more external communication networks. While FIGS. 1 and 2 illustrate the devices 22, 32a, 32b, and/or 32c as being mobile devices they are not so limited. In one form of the present technology, one or more of the devices 22, 32a, 32b, and/or 32c may comprise a desktop computer, a laptop computer, a mobile phone, a smart watch, or a tablet.

Proposal to Project Completion Workflow

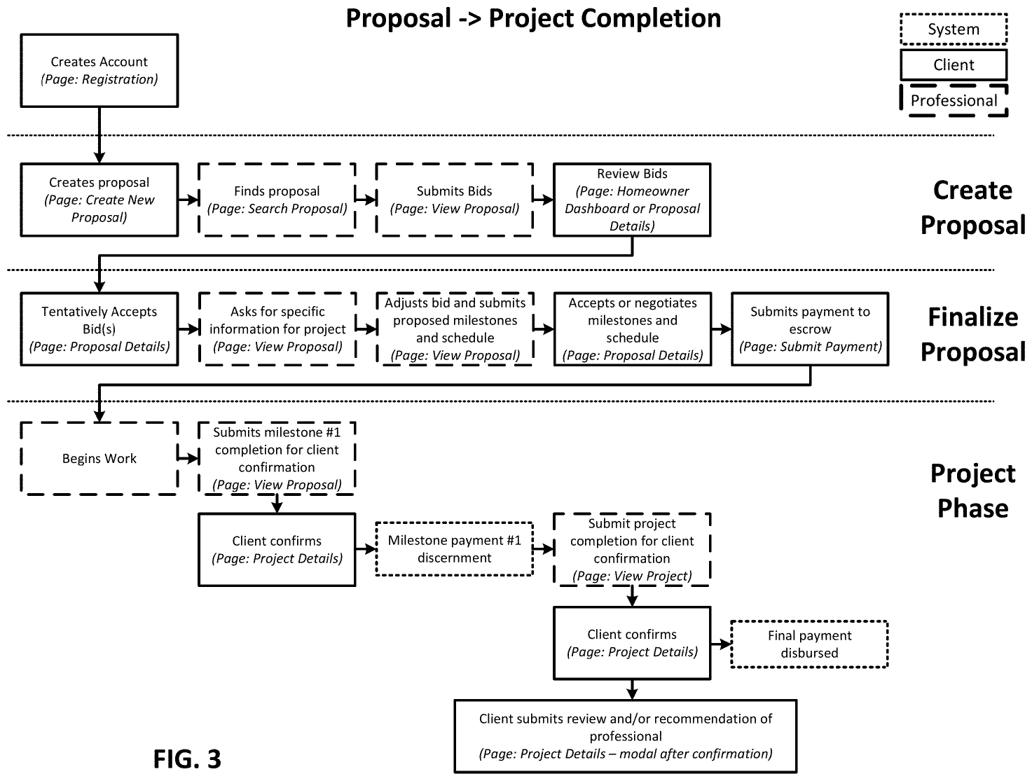

FIG. 3 illustrates a proposal to project completion workflow according to an embodiment of the present disclosure. The operations shown in FIG. 3 are illustrated as being performed by the system, the client and the professional according to one form of the present disclosure. The operations performed by the system may be performed by or using the central processing system 40, the operations performed by the client may be performed by or using device 22, and the operations performed by the professional may be performed by or using the devices 32a, 32b, and/or 32c. One or more shown operations may be omitted and/or performed by another device in some examples of the present technology.

As shown in FIG. 3, the workflow may include three phases: a create proposal phase, finalize proposal phase and a project phase. The client device and the professional device may receive and provide information to the system in each of the phases.

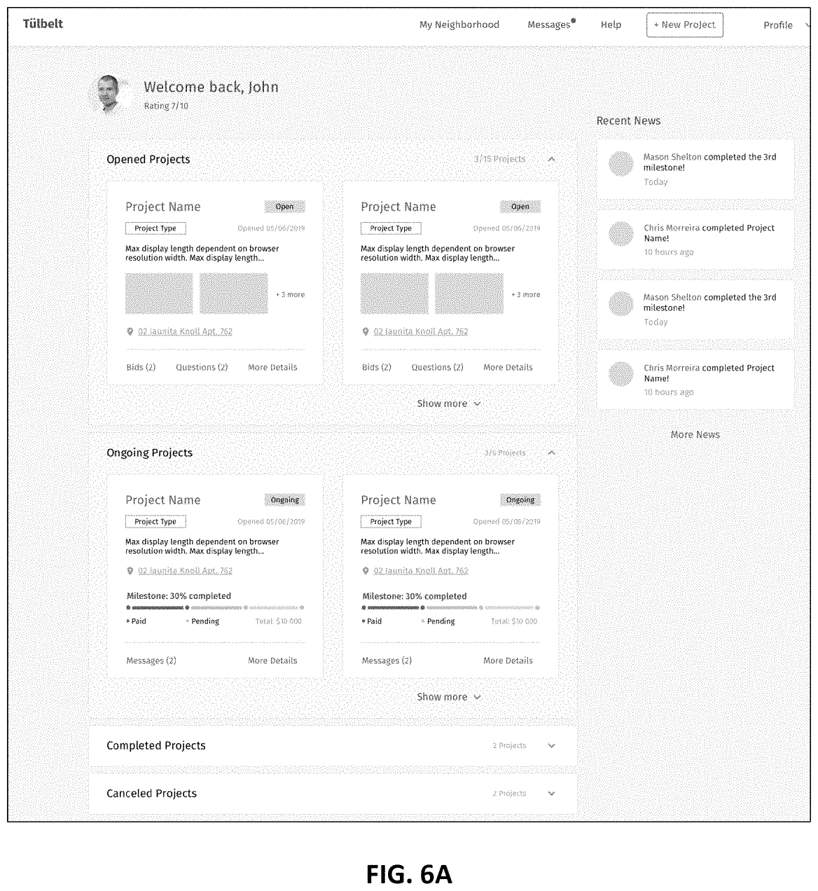

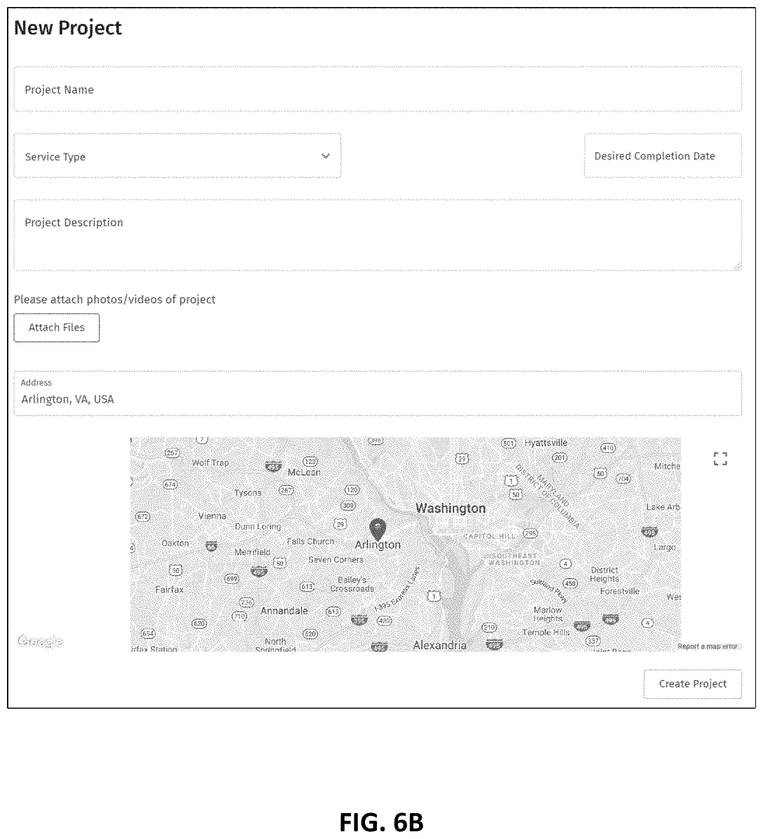

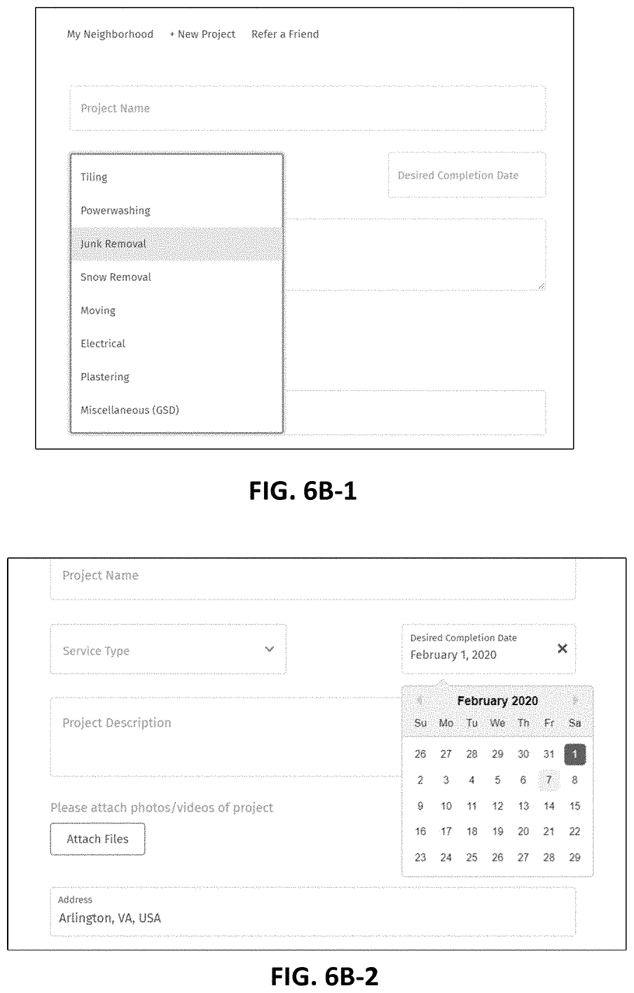

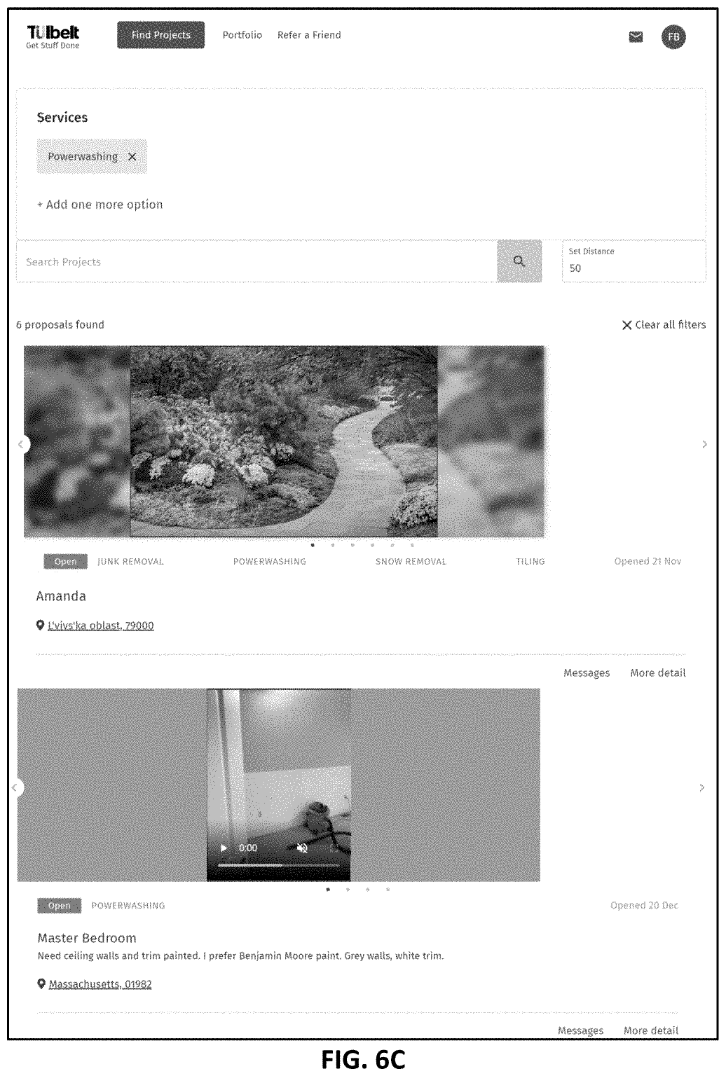

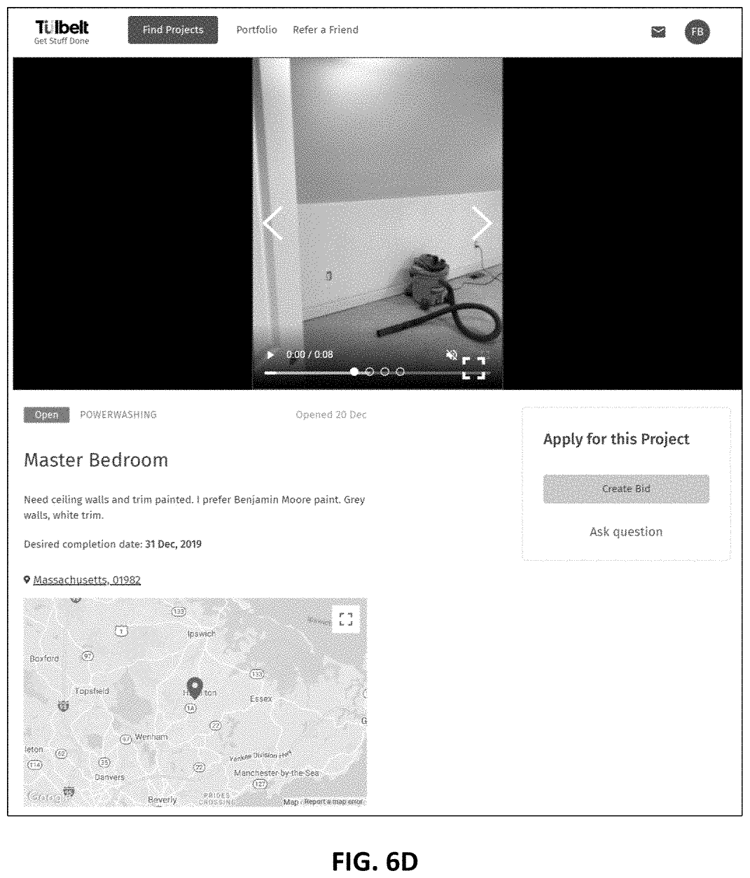

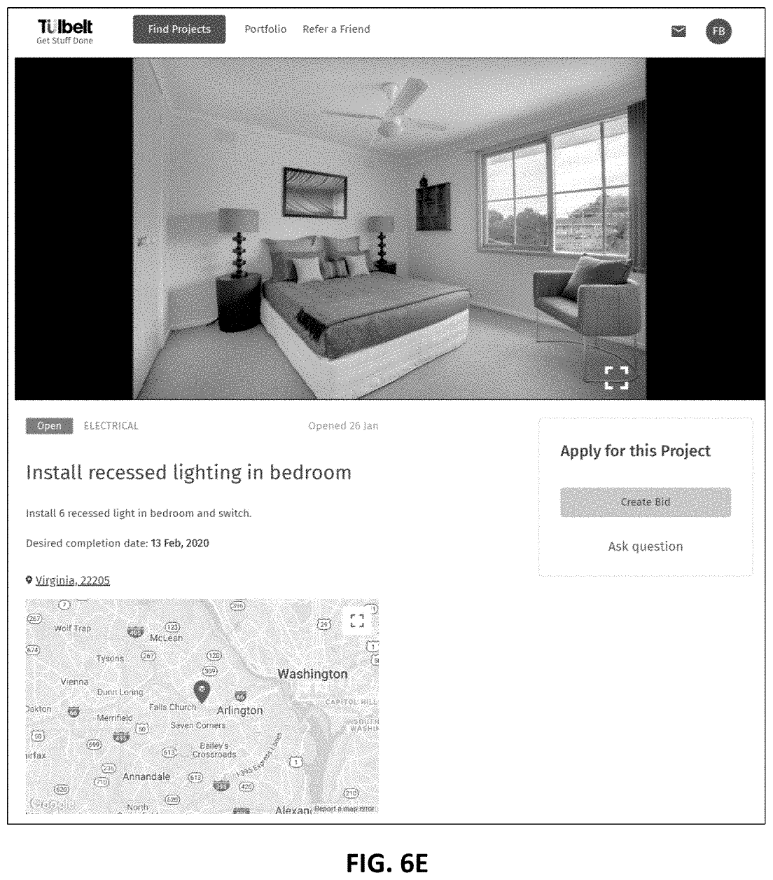

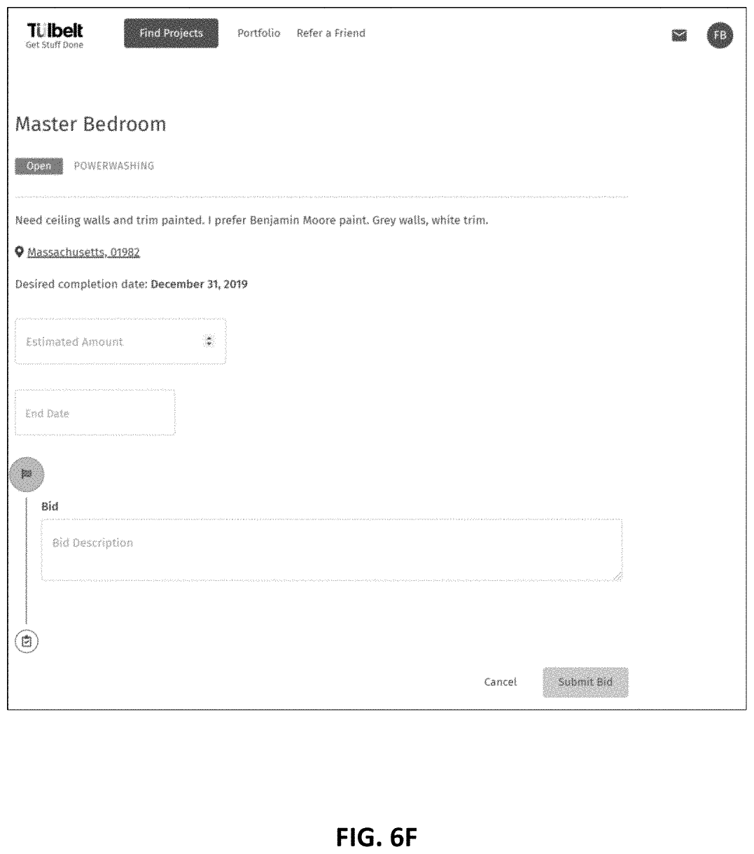

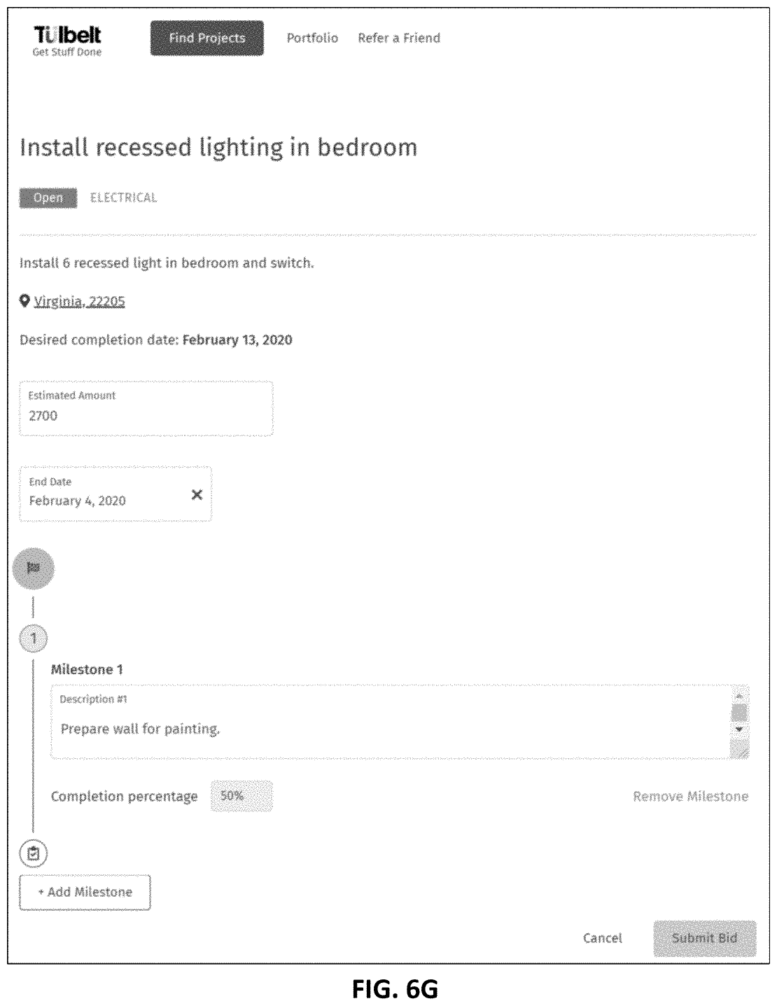

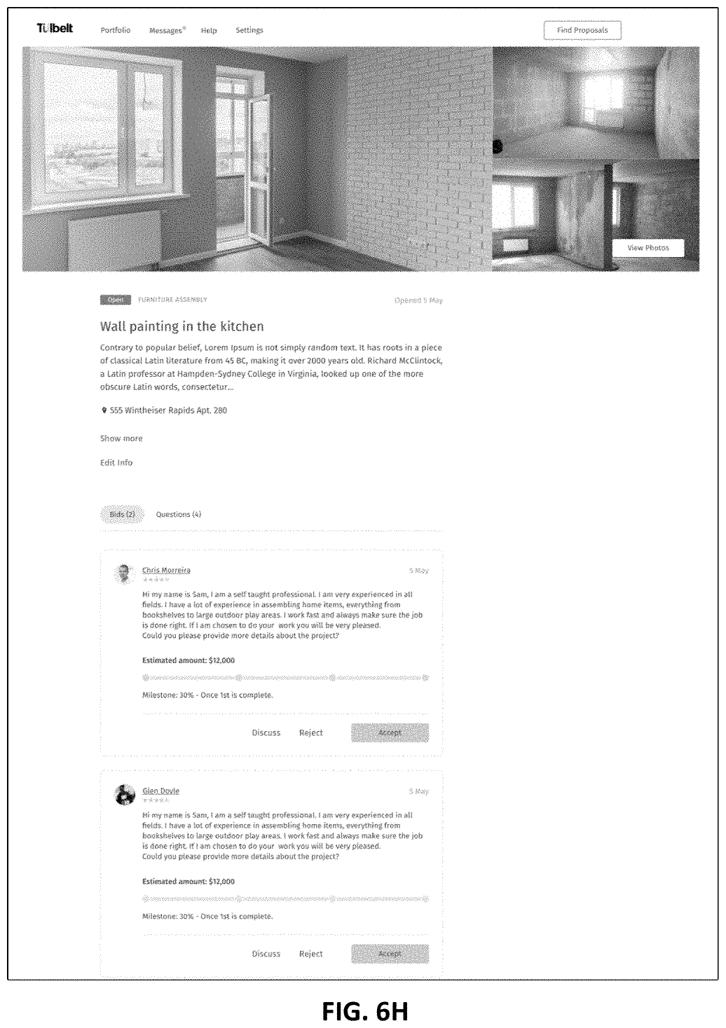

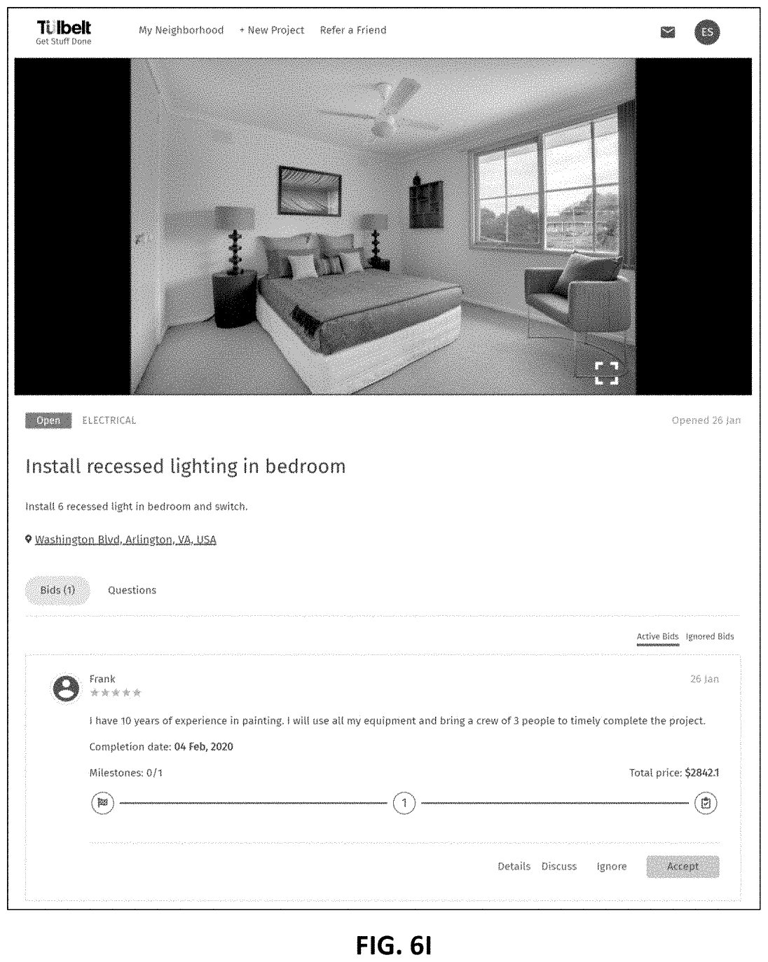

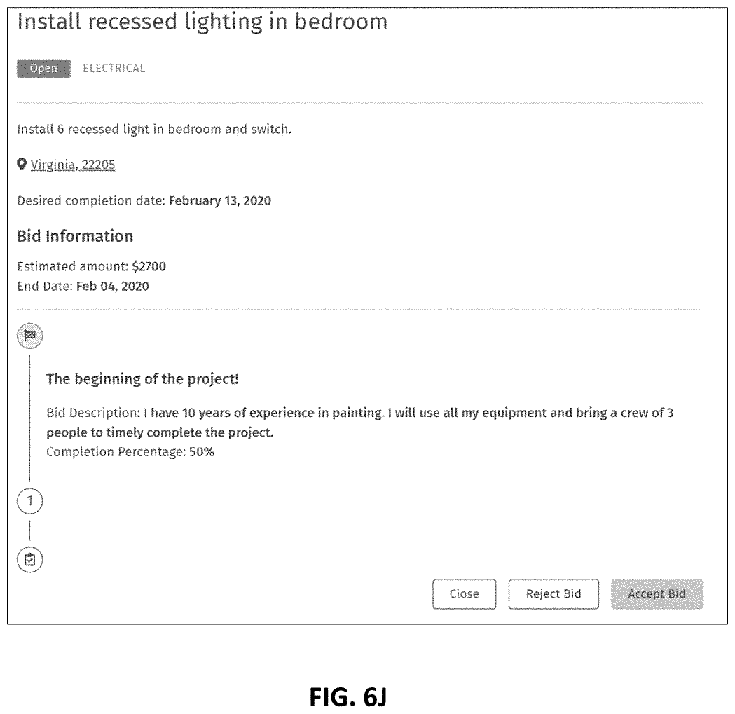

After creating an account, a registered client may be provided with a personalized client dashboard. FIG. 6A shows an example of a client dashboard that may be displayed on a display of a device. The client dashboard may include one or more of opened projects, ongoing projects, completed projects and/or canceled projects. As shown in FIG. 6A, the client is provided with an option to create a new project. In addition, a recent news section of the display may include information about one or more completed objects providing projects completed by professionals for other clients in a physical area associated with the client.

Selecting to create a new project includes providing information for a proposal. FIG. 6B shows an example of a screen that can be displayed to create a new project proposal on a client device. While FIG. 6B shows a single screen displaying different information that may be input by the user, one or more of the details for the project may be input in different screens. In some example, the one or more inputs may be provided on a different screen from one or more inputs received on another screen to accommodate smaller screens included in mobile devices.

The screen shown in FIG. 6B includes an option to select a project name, service type, desired completion date, and project description. The service type may include painting, landscaping, plumbing, electrical, remodeling, minor home renovation, major home renovation, power washing, junk removal, snow removal, moving, plastering, cleaning, landscaping, miscellaneous, etc. The available service types may be selectable from a menu in response to receiving an input (e.g., a touch input) to “service type” option. FIG. 6B-1 shows an example of a list of selectable service types. In some example, a user may be provided with an option to enter a service type not included in the available service type list.

Desired completion time may be selected (e.g., using a touch input) to provide a date. FIG. 6B-2 shows an example of a calendar showing selectable dates for completion time of the project. In some examples, the client may provide a time range including a plurality of consecutive or non-consecutive days for the project completion. In some examples of the present technology, the client may input that the project needs to be completed as soon as possible. In some examples, alternatively or in addition to providing the desired completion time, the user may input a single or a plurality of days (consecutive or non-consecutive) on which the project can be performed.

The client may also be provided with an option to attach one or more files and/or provide a location of the project. In some examples, the attach file option or another selectable option may allow the client to capture one or more pictures or videos of the project using a camera on the device or an external camera in communication with the device. The external camera, which may be provided on an aerial vehicle, may be configured to wirelessly communicate with the device. The captured pictures and video may be associated with the new project.

In some examples, the captured image(s) and/or the video may be annotated with text and/or markings to provide additional information about the project. For example, the client may annotate the captured image(s) and/or the video to include dimensions of the project. In some examples, the system 40 may analyze the submitted images and request the client to enter dimensions for extracted objects (e.g., height of a room, door width, and window dimensions). In some examples, the system may, based on the type of project, automatically extract certain features from the images and provide them as separate images and request the client to enter dimensions for the extracted features. For example, if the project is to replace windows the system may extract each window from the images and request the user to enter a dimension for each window. Feature matching may prevent the same windows in different images from being listed multiple times.

The captured images and/or videos may be associated with the time and/or location of the device at the time the images and/or videos are captured. The time and/or location of the device may be added to the project information. The location of the device automatically adding the time and/or location of the images and/or video may ensure that the information provided for the project is accurate and represents the most recent condition of the project. In some examples, the system may be configured to require that the images and/or videos are captured within a predetermined time frame (e.g., 7 days) from when the project is requested or require that the user capture an image and/or video at the time the new project is requested. The location information may be captured by one or more sensors in the client device and transmitted to the system with the images and/or video. In some examples of the present technology, location information and time associated with the images and/or the videos may be extracted by the system from the metadata associated with the images and/or the videos.

In some examples, the client may attach files of other physical locations to provide examples of how the client wants the completed project to look. The user interface on the client device may provide a user with an option to indicate whether a picture being uploaded is of the current state of the physical location and/or desired outcome for the physical location. In some examples, the client may provide internet links to images and/or videos of other physical locations to provide examples of other completed projects. The client may be provided with an option to provide a description for each image or video.

In some examples, attaching one or more files may include the client uploading files that are not limited to images and/or video. The client may upload other documents including cad drawings, floor plans, work permits, government or home owner's association citations, and/or legal documents.

As shown in FIG. 6B, the client may be provided with an option to input a project description. The project description may include one or more of dimensions for the project, materials to be used, and/or timeframe for the project. In some examples, the system may be configured to suggest one or more details and/or require one or more details about the project based on the selected service type and/or information extracted from the images and/or video.

The location input provides a physical location of the project. As shown in FIG. 6B, based on the input location, a map of the location may be displayed. In some examples, the system may be configured to automatically retrieve map information from an external source based on the input location information, type of project and/or features in the images and/or video. In some examples, the displayed map information may include satellite or other aerial images of the project location.

In some examples, terrain and/or three-dimensional information of surrounding infrastructure may be retrieved and included with the project description. The retrieved three-dimensional information may include dimensions of the property, house, and/or roof. In some examples, information about utilities in the specified location and/or surrounding area may be retrieved by the system and included in the project description. According to one form of the present technology, additional information such as images, dimensions, and/or information about utilities may be automatically retrieved based on the type project selected by the client.

Based on the input and/or retrieved information, the system creates a new project associated with the client. The create proposal stage shown in FIG. 3 includes one or more professionals finding proposals and submitting bids for the proposals. The system using the information input by the client generates a request for proposal. The request may be transmitted to the devices of the professionals for display on the screen. The request for proposal may be included in a list categorized based on the type of proposal request, sent in an email, sent in a text message, or sent via a message in an application. In some examples, the proposal request may be published to outside market place services or messaging applications.

The professional may use his or her device to find proposals on which he or she wants to place bids. FIG. 6C shows an example screen that may be displayed to a professional for searching for proposals. The screen may be displayed in response to selecting a find proposal option. The search proposal screen may allow a user to select one or more filters for the search. The filters may include a project type, distance to project, and/or keyword search. FIG. 6C shows projects satisfying a power washing and located within 50 miles filters.

The projects located within a predetermined distance may include projects within a predetermined distance from the professional's location (e.g., business location or home location) indicated in the profession's profile. In some examples, the current location of the professional's device determined from one or more sensors included in the device may be used in determining projects that are within a predetermined distance from the professional's device. With this example, a professional having additional time after completing a certain project may determine if there are additional projects nearby that can be completed within availed time (e.g., on the same day or duration of stay in a specific physical location).

The results may include a summary view of each project matching the search. The summary view may include showing one or a plurality of images for the project, project name, at least a portion of the description, project opening date, project status and/or location information. The screen may include an option to show messages associated with the project and/or more details about the project. The option to show messages may include showing any previously sent and/or received messages between the client of the project and the professional performing the project search. As shown in FIG. 6C, a main image or video is displayed for the project and the user may scroll through the plurality of images and/or videos associated with the project. The summaries of the projects allows the professional to preview the matching projects on a single page or screen without needing to separately view pages associated with each project.

FIGS. 6D and 6E show example screens of a detailed view for a project. The screens shown in FIGS. 6D and 6E may be displayed when the professional selects a corresponding project summary shown in FIG. 6C. The detailed view for the project may be generated based on information about the project input by the client in FIG. 6B. The detailed view for the project may include an option to provide a bid for the project and/or send the client associated with the project a message.

FIGS. 6F and 6G show example screens for inputting a bid for a project. The screen shown in FIG. 6F may be displayed when the professional selects create bid option shown in FIG. 6D. The screen shown in FIG. 6G may be displayed when the professional selects create bid option shown in FIG. 6E. The screens for placing the bid may include information about the project (e.g., project name and description) and an option to enter a bid amount. In some examples, the bid amount may include categories for different portions of the bid, and a bid total may be displayed. For example, the bid may include a portion of the bid for material cost, a portion of the bid for labor cost, a discount amount for one or more costs, travel cost and/or one or more other costs.

Entering the bid information may include inputting a project end date and/or a bid description. The bid description may include details about materials that will be used for the project, number of days needed to complete project, modifications to conditions in the project description, information about professional, and/or other information. In some examples, providing the bid information may include inputting a duration (e.g., 3 days) during which the bid offer is valid or a date the bid will expire.

Entering the bid information may include inputting one or more milestones for the project. FIG. 6F show bid information entered without one or more milestones. FIG. 6G shows a milestone added to the bid information. In some examples, at least one milestone may be provided for projects that exceed a predetermined bid amount. For example, a milestone may be required when the bid amount exceeds $1,000. In some example, a plurality of milestones (e.g., two milestones) may be required when the amount exceeds a second predetermined amount (e.g., $25,000). The system may be configured to automatically require at least one milestone when the bid amount exceeds the preset bid amount. In some examples, the milestones may be optional or not included in the bid submission.

The milestones may be defined by the professional. As shown in FIG. 6G, the user inputs one milestone and inputs a description. The single milestone is associated with 50% completion of project. In some examples, the professional may be provided with an option to modify the completion percentage for each milestone. As shown in FIG. 6G, the display includes an option to add additional milestones and associated descriptions.

Entering the bid information may include uploading one or more files. The user interface may include an option for the professional to upload the one or more files and transmit them to the service. The service may include the one or more files with the bid information that is transmitted to the client device.

The uploaded files may include, images, videos, cad drawings, floor plans, certifications, and/or legal documents. The uploaded files may help the client device whether to accept or decline a bid. In some example, the client may request for the professional to provide certain information with the bid. The requested information may include diagrams, design ideas, floor plans for the proposed project. In one example, the client may upload a landscaping diagram and request the professional to submit a landscaping layout with the specific plants the professional is proposing to install.

After entering the bid amount and other information, the professional may submit the bid. The system may receive the bid information from the professional's device and transmit the bid information to the client's device. In some examples, the system may notify the client (e.g., via a text message or email) indicating that one or more bids are available for review.

After one or more bids are received from one or more professionals, the bids may be provided to the client.

Finalize Proposal

The bid information may be displayed on the client device and include an option to accept the bid. In some examples, the client may be provided with an option to decline the bid. In some examples, if a bid is declined, the user interface may prompt the client to answer one or more questions on why the bid was declined for the professional to review. The professional may be notified with the responses to decide whether to resubmit a modified bid.

FIGS. 6H and 6I show example screens providing bid information that may be displayed on a client device. FIG. 6H shows bid information received from a plurality of different professionals. FIG. 6I shows bid information received from a single professional. The bid information may include displaying information about the professional (name and/or rating), bid amount, description of bid, and/or options to accept bid, ignore bid, discuss bid, and/or see more details about the bid.

Receiving an input to reject or ignore the bid may move the bid to a group of ignored/rejected bids. Receiving an input to discuss the bid may provide an option to send a message to the professional associated with the bid.

Receiving an input to display more details about the bid may display an additional screen with details about the bid. FIG. 6J shows an example of a screen that may be displayed when “details” is selected in the screen shown in FIG. 6I. Selecting a milestone in FIG. 6J or 6H may display details about the milestone. FIG. 6I show a screen including details of the milestone when the first milestone is selected in FIG. 6H.

After an input is received on the client device indicating the client selected the bid, a notification may be received by the system and transmitted to the professional (e.g., the client device associated with the professional). In some examples, accepting the bid may tentatively accept the bid conditional upon the client and professional reaching an agreement on project details and/or receiving a payment from the client. According to one example of the present technology, upon selecting an option to accept the bid, the client may be displayed an interface to enter payment information. When a bid is accepted, the status of the proposed project may be changed to “pending” or “not available” to indicate to other professionals that the client selected another professional for the project.

With reference to FIG. 3, after the bid is tentatively accepted, the finalize proposal phase may include asking specific information for the project, adjusting the bid (if needed), submitting proposed milestones and schedule, accept or negotiate milestones and schedule, and/or submit payment to escrow. After the professional receives a notification of accepting the proposal, the professional may be provided with an option to ask additional specific questions about the project and/or option to adjust bid, proposed milestones and/or schedule. The client is displayed an updated bid proposal and is provided with an option to accept or further modify the project proposal and/or changes to bid, milestones and/or schedule. After the client is satisfied with the bid and conditions, the client may accept the bid and provide to escrow.

In some examples of the present technology, the milestones may be input only after the bid is initially accepted by the client. In this example, the milestones may be input by the client or the professional after the bid is accepted.

In some examples of the present technology, one or more milestones may be input by a professional and one or more milestones may be input by the client. In this example, the user interface may include a graphic or text indicating whether the professional or client input the corresponding milestone.

In some examples of the present technology, the client and the professional may provide modifications to the bid and project proposal before the client tentatively accepts a bid. In one example, the interface may not include an option to tentatively accept a bid and only provide an option to accept a bid after the client and/or professional are satisfied with the bid and project proposal.

Project Phase

The project phase includes operations related to performing work by the professional, completing the project, submitting payment(s) and providing reviews of the client and/or professional.

After the bid is accepted, the professional is provided with an indication that the project can be started. The client and professional may communicate with each other using the system messaging and/or chat service to provide a record of any agreements and/or disagreements. The professional may provide an indication using the device when a milestone and/or completion of the project is reached.

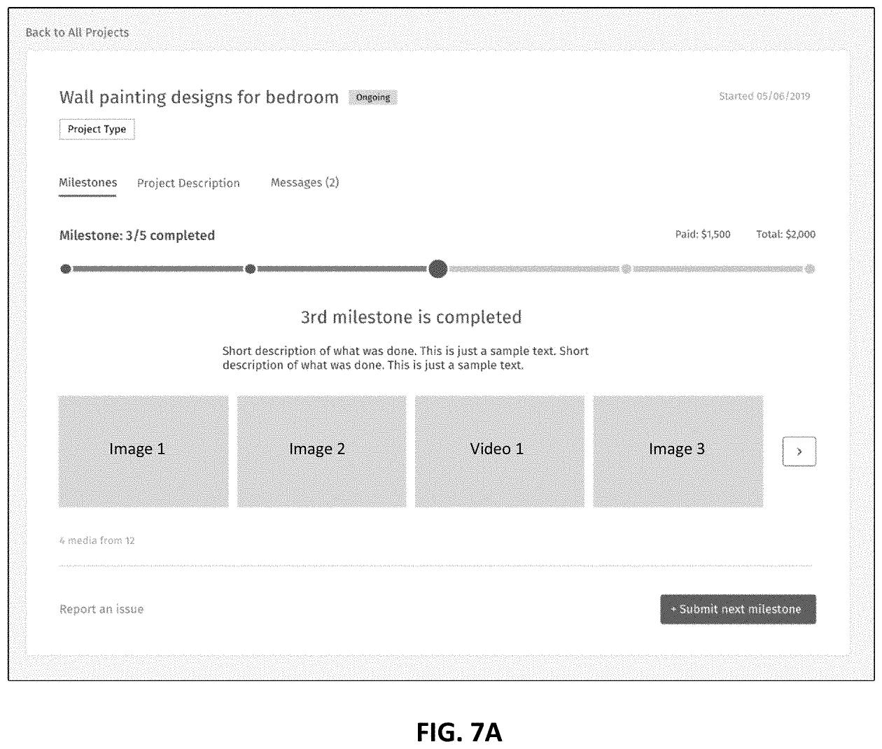

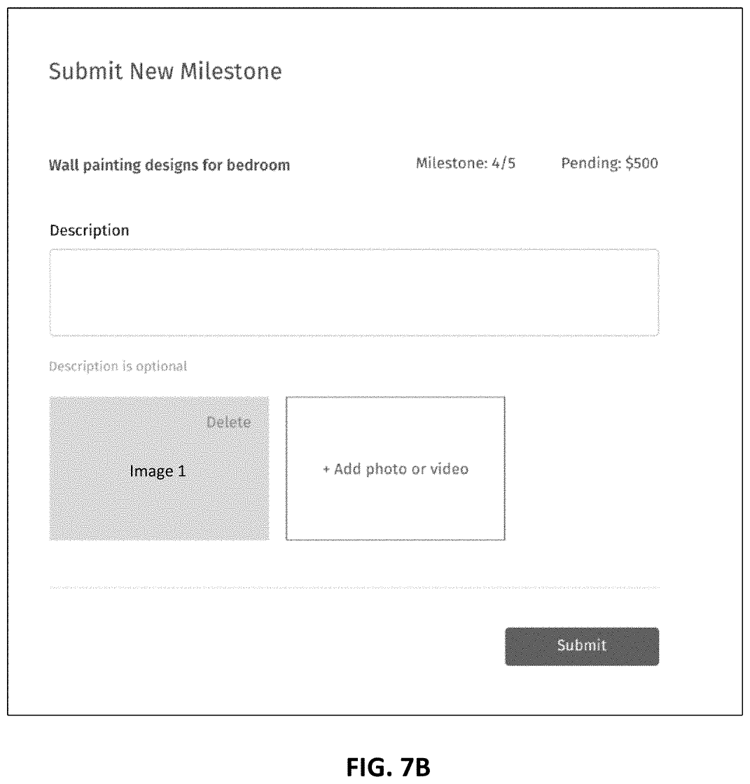

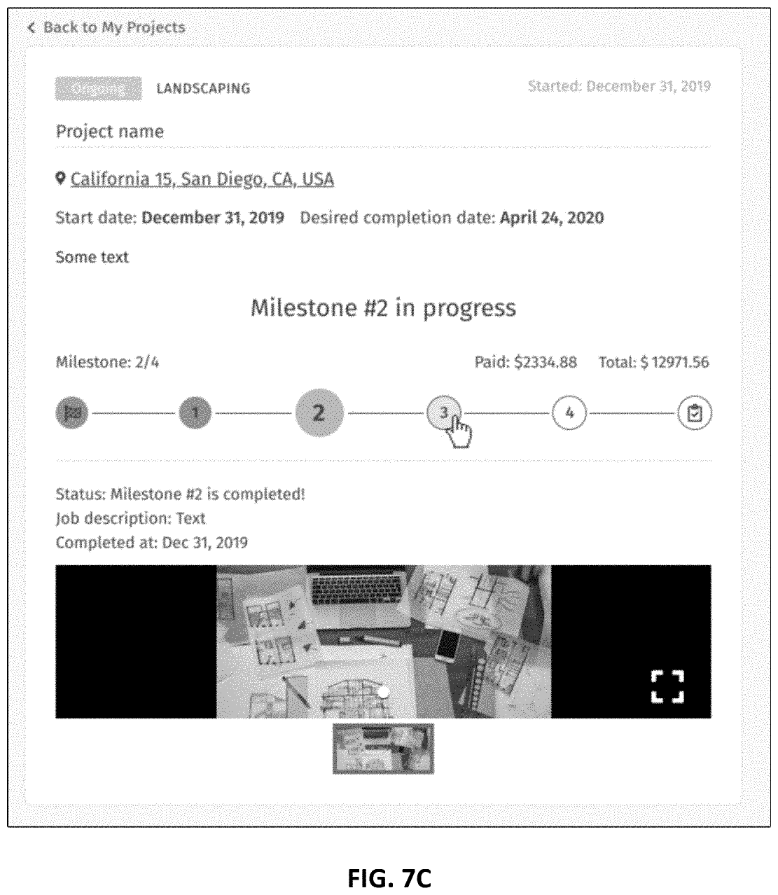

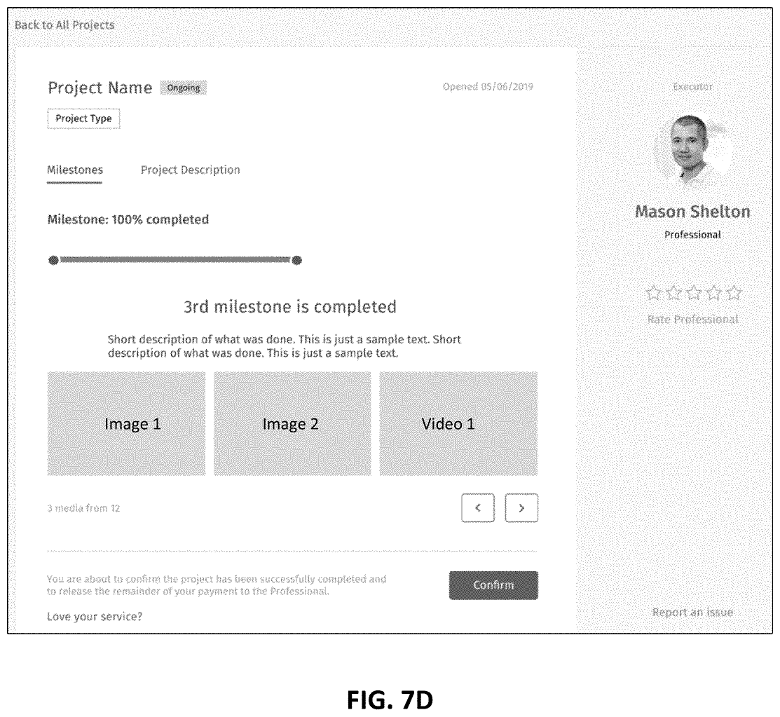

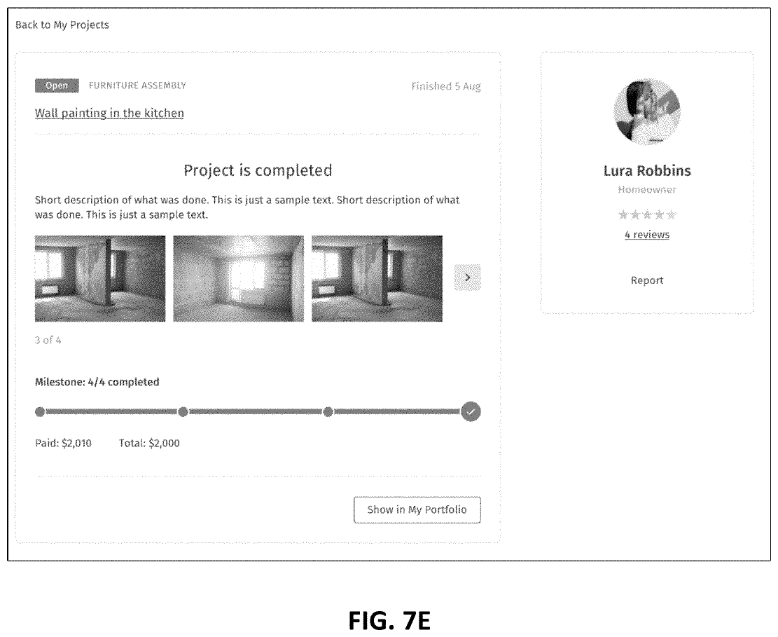

FIG. 7A shows a screen that may be displayed on a professional's device showing progress of a project according to an embodiment of the present technology. The project includes a plurality of milestones. One or more completed milestones include a description of what was done for the respective milestone. In some example, each milestone may include one or more images and/or videos showing the completed work associated with the milestone. As discussed above, a portion of the fund in escrow are released after a milestone is indicated as being completed by the professional and a confirmation is received from the client.

When a milestone is complete, the professional may provide an input to submit the next milestone. FIG. 7B shows a screen that may be displayed when an input is received by the professional to submit the next milestone. As shown in FIG. 7B, the professional may have an option to enter a description of performed work related to the milestone (e.g., what has been completed) and provide one or more videos and/or photos. FIG. 7B also shows an amount of funds in escrow associated with the milestone.

When the professional submits the milestone, information input by the professional is transmitted by the professional's device and received by the system. The system transmits the milestone information to the client and requests a confirmation that the milestone is complete. After receiving the confirmation from the client, funds associated with the milestone are released from escrow to the professional. These operations may be repeated until each milestone is complete.

FIG. 7C shows an example screen that may be displayed on a client device showing the progress of the project and milestones. Selecting completed milestones may display information provided by the professional with the completed milestones. Selecting a pending milestone may show information about the upcoming milestone, and if information is provided by the professional for the pending milestone, an option for the client to confirm completion of the milestone.

FIG. 7D shows a milestone confirmation screen that may be displayed to a client on a client device. The screen includes information input by the professional (e.g., description of completed work, images and/or video) and an option for the client to confirm the milestone. In some example, the client may be provided with a time limit (e.g., 24 or 48 hours) in which a confirmation needs to be provided. If additional time is needed, the client may request a time extension to confirm the milestone (e.g., if additional time is needed to inspect the work product). If the client is not satisfied with the completion of the milestone, the client may request the professional to correct an issue and/or report an issue for the system administrators to resolve.

After the professional completes all of the milestones, the professional may submit the project for final completion and a confirmation may be received from the client. After receiving the final completion confirmation, final payment may be disbursed to the professional.

After the project is completed, the client and/or the professional may provide a review for the completed project. The reviews may be associated with the client profile and the professional profile.

The professional may also be provided with an option to share information about the completed project in the professional's portfolio. FIG. 7E shows a completed project summary that may be displayed on a professional's device. The screen includes a summary of the project and milestones, and an option to show the completed project in the professional's portfolio. Selecting the “Show in My Portfolio” option may add information associated with the completed project to the professional's portfolio. The added project may be marked as verified in the professional's portfolio based on the client confirming completion of the project.

Project and Payment Flow

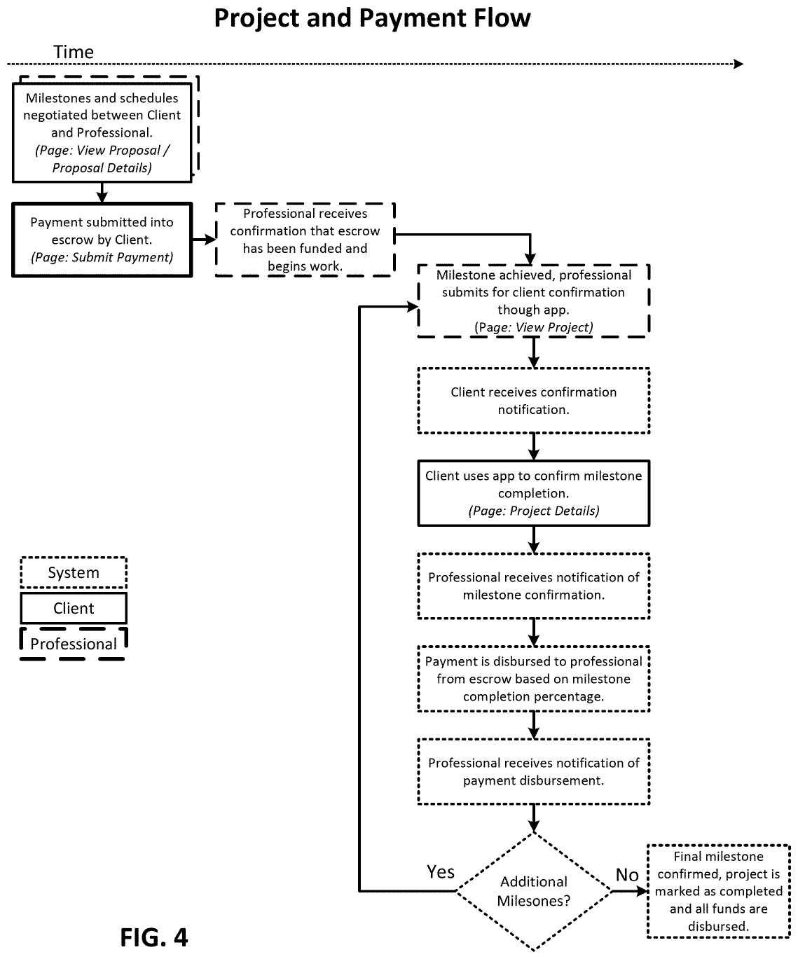

FIG. 4 illustrates a project and payment flow according to an embodiment of the present disclosure. The operations shown in FIG. 4 are illustrated as being performed by the system, the client device and the professional device according to one form of the present disclosure. One or more shown operations may be omitted and/or performed by another device in some examples of the present technology.

The milestones and schedule for the project are negotiated between the professional and the client (see FIG. 3 and associated description). After the project proposal is accepted, the payment is submitted by the client into escrow. After the payment is received, the system provides the professional with a notification that the escrow has been funded and work can be started based on the accepted project proposal.

When a milestone is completed, the professional submits information for the completed milestone (see FIG. 7B). Based on the submitted milestone completion information, the system creates a milestone completion report and transmits a milestone completion notification.

After receiving the milestone completion notification, the client may use the application or a webpage to review and confirm the milestone completion (see FIGS. 7C and 7D). The system receives the milestone completion confirmation from the client device.

After the milestone is confirmed by the client to be completed, the professional receives a notification of the milestone confirmation and payment is disbursed to the professional from the escrow. The amount disbursed may be based on milestone completion percentage. In some examples, the disbursed amount may be an amount that is negotiated for each milestone during project proposal negotiation (e.g., an amount proposed by the professional or client). In some examples, a first disbursement may be determined based on an equation in which the amount is determined based on percentage of work completed. The equation may be a linear equation or an exponential equation.

After the payment is disbursed, the professional may receive a notification of payment disbursement. The notification may be transmitted by the system via an application, notification in the professional's account, an email, and/or a text message.

As shown in FIG. 4, a determination may be made as to whether additional milestones exist. If additional milestones exist in the project, then the operations discussed above may be repeated. If no additional milestones exist, then the system may receive a project completion from the professional and a confirmation from the client. After receiving the confirmation from the client, the final funds in escrow may be disbursed.

In some examples of the present technology, after the project is confirmed to be completed, the client may be prompted with an option to provide a tip to the professional. The tip may be added to the final disbursement of funds from escrow.

Proposal Sourcing

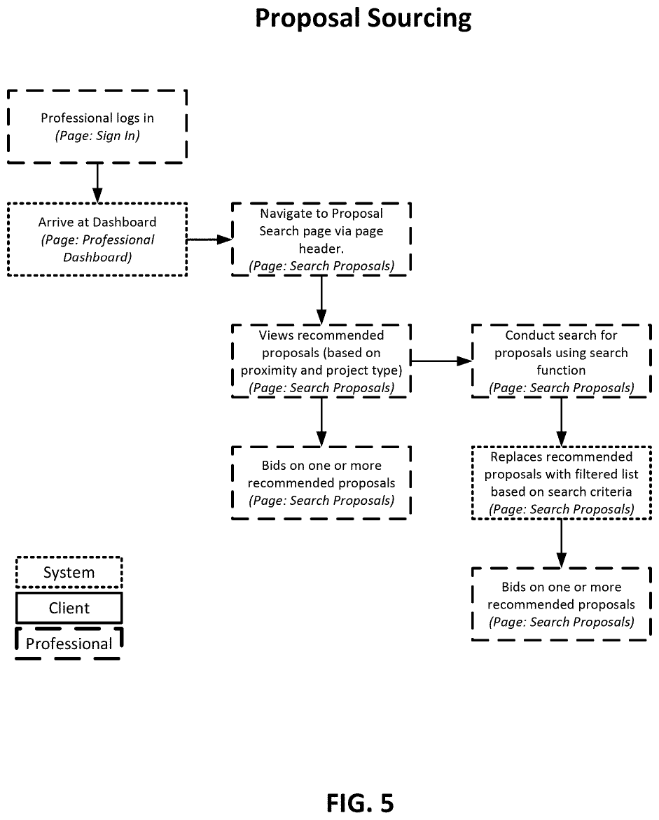

FIG. 5 illustrates a proposal sourcing workflow according to an embodiment of the present disclosure. The operations shown in FIG. 5 are illustrated as being performed by the system, the client device and the professional device according to one form of the present disclosure. One or more shown operations may be omitted and/or performed by another device in some examples of the present technology.

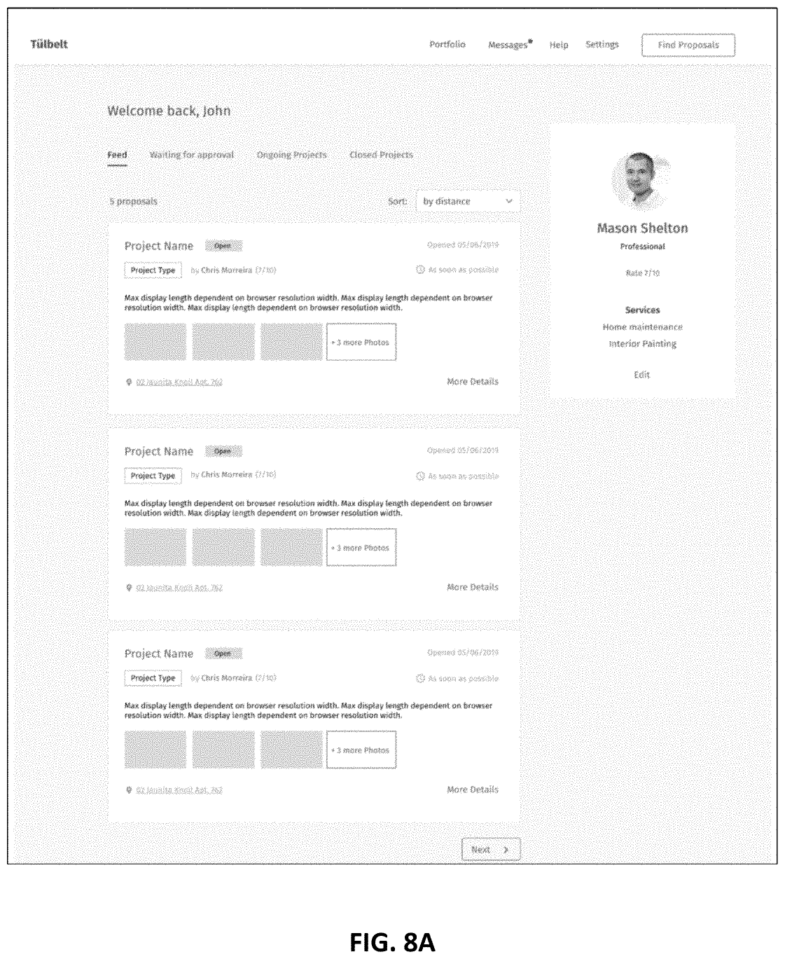

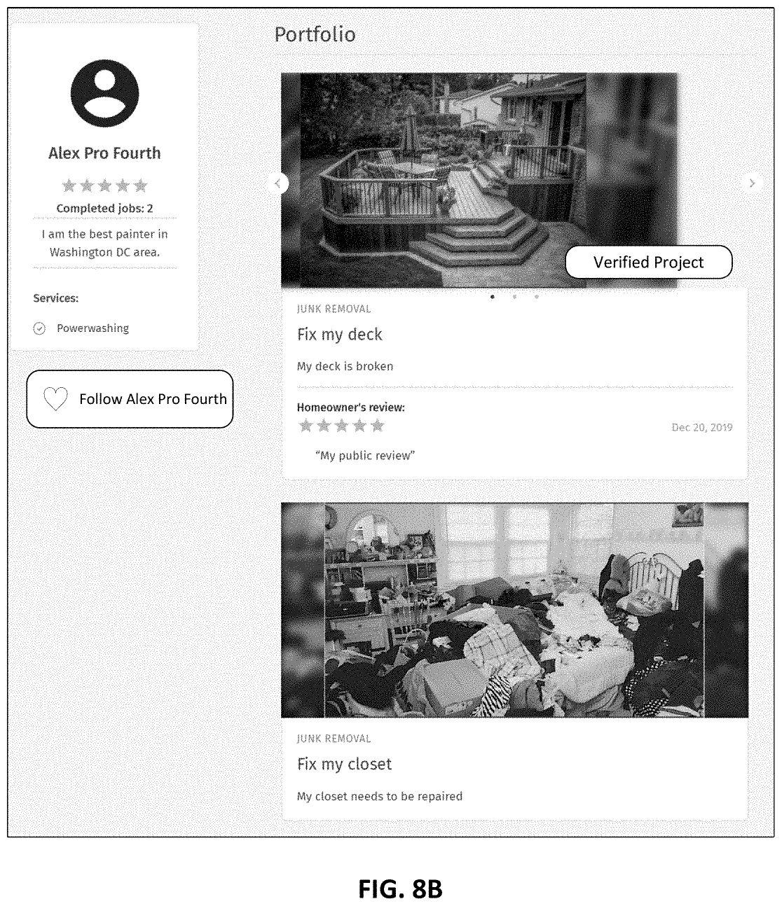

After the professional logs into his account, a dashboard is displayed. FIG. 8A shows an example of a professional's dashboard screen including a project feed. The professional's dashboard may include an option to view projects waiting for approval, ongoing projects, and closed projects.

As shown in FIG. 8A, an option may be provided to find proposals. In response to selecting the option to find proposals, a search proposal screen is displayed. The search proposal page may display one or more recommended proposals. The recommended proposal may be automatically determined based on proximity, project type, completed projects, and/or professional profile. The professional may select one of the recommended proposals to review and bid on the project. Alternatively, the professional may conduct a search using a proposal search function (see FIG. 6C).

Based on the search results, recommended proposals may be replaced with a filtered list based on the search criteria. The professional may review and bid on the project provided in the search results.

In some examples, an interactive map may be displayed with nearby projects matching one or more search criteria. The interactive map may include a layer displaying nearby proposals available for bidding.

My Neighborhood

In some examples of the present technology, the system may provide a neighborhood feature to allow clients and/or professionals to see projects that have been completed, pending or proposed. In one example, a customer (homeowner) may see all the projects their neighbors are having done. The customer may increase/decrease the radius beginning with their home location, to include as wide or narrow area as they choose. The customer may be shown the names of projects, pictures of projects and the professionals working on those projects. The system may provide a photo and/or video sharing social networking service in which projects being done in neighbors' homes, with before/after work progression pictures/videos.

In one example, the user interface managed by the system may display a map with overplayed features indicating locations of the projects. Selecting the feature may provide more details about the project. In another example, the user interface managed by the system may provide a news feed with the projects. The news feed may include summaries of projects (e.g., an image with brief description) and selecting a project may retrieve additional information about the selected project.

Location Confirmation

In some examples, a location of the device may be used to confirm that the information (e.g., images and/or videos) provided by the client and/or professional are associated with the location of the project. The confirmation of the location may reduce the professionals and/or client providing false or outdated information.

The client device and/or device of the professional may capture location of the device using one or more sensors on the device. For example, the device may use GPS sensor and/or accelerometer to provide the device's location and/or orientation. When the client inputs project information, the system may require or provide an option for the client's device to provide location information. The location information may be received when the client device uploads the images and/or video. In this manner, the system may confirm that the uploaded images are captured at a location that is designated by the user for the project.

Similarly, the professional may be required or provided with an option to provide the device's location information when images and/or video are uploaded for milestones and/or completion of the project. The system may confirm that the location information provided with the images and/or video are matched to the location of the project. The system may provide an indicator on or next to the images and/or videos to show that images are verified with the location of the project.

Verifying the images and/or video with the location of the device may reduce client and/or professional uploading outdated images and/or videos and ensure that the images being uploaded are of the location of the project.

In some examples of the present technology, the client and/or professional may be required to use the device to capture the images and/or video at the time proposal is requested or milestones are submitted. In this example, the client and/or professional may be prevented from uploading images and/or videos that are pre-stored on the device. This may be desirable in some implementations to reduce the possibility of the image and/or video being edited, being outdated or being of the wrong location.

FIG. 8B shows a professional portfolio screen according to an embodiment of the present technology. The screen may be displayed when a client selects to review a professional's profile. The professional portfolio may include information about one or more completed projects. The completed projects may be selected by the professional. In some examples, the professional may input information from projects that are performed outside of the marketplace platform. Information for projects performed within the marketplace platform may be marked as verified by text or graphic (see FIG. 8B). In some examples, verified indicators (text or graphic) may be provided on images that are verified with the location of the project.

As shown in FIG. 8B, the client may be shown an option to follow the professional. Following the professional may link the client and the professional and provide updates when the profile of the professional changes, projects are started, and/or projects are completed. The professional may be provided with an option to send out announcements, discounts, availability for new projects, and/or offers for specific projects to linked clients.

A professional may be provided with an option to follow a client. The professional may be notified when a client they follow posts new projects.

In some examples, the system may be configured to automatically set a client to follow a professional, when the client provides a rating above a predetermined value (e.g., 4 out of 5 or higher rating). Similarly, the system may be configured to automatically set a professional to follow a client, when the professional provides a rating above a predetermined value (e.g., 4 out of 5 stars or higher rating).

In some examples, other clients and/or other professionals registered with the platform may be provided with an option to rate and/or comment on projects in a professional's profile. The professional may be provided with an option to remove one or more comments provided by other clients and/or professionals.

In some examples of the present technology, professionals can endorse other professionals and/or their particular skill sets. Professionals can also follow customers and professionals, like/love to projects and progression pictures/video, and comment on them.

In some examples of the present technology, the system may be configured to allow a client to submit proposals to specific professionals. For example, when preparing a project proposal, the user interface may display an option to send the proposal to one or more of professionals the client follows and/or professionals the client previously used for other projects. The system may receive the targeted request from the client device and transmit the request for bids to the selected professionals without posting the project proposal for other professionals to bid on.

In some examples of the present technology, the platform may provide an interface to allow professionals to find projects and/or find subcontractors for projects they are assigned. The projects a professional is assigned may include a project that the profession bid on and was accepted by a client according to various embodiments disclosed in this application or a project obtained outside of the disclosed platform.

Similar to the user interface discussed above for providing a professional profile, a professional may input his or her availability to provide services as a subcontractor. A contractor may perform a search using specific criteria (e.g., experience, certifications, location) to find one or more contractors and send them proposals for projects. The subcontractor may review the proposal and accept, decline or submit a modified proposal.

In one form of the present technology, the user interface on a professional's device may allow the professional to switch from their professional profile, to a contractor/customer profile (e.g., subcontractor profile) to post jobs as a contractor, and accept bids from other professionals. In this example, a contractor may post information about a specific job of a project they are managing and receive bids from one or more subcontractors. A subcontractor may search for projects that they may be interested in, similar to the examples provided above for a professional searching for projects posted by a client.

These examples may allow a contractor to use the platform to manage large residential and/or commercial projects needing multiple professional providing the same or deferent types of services.

Example Device

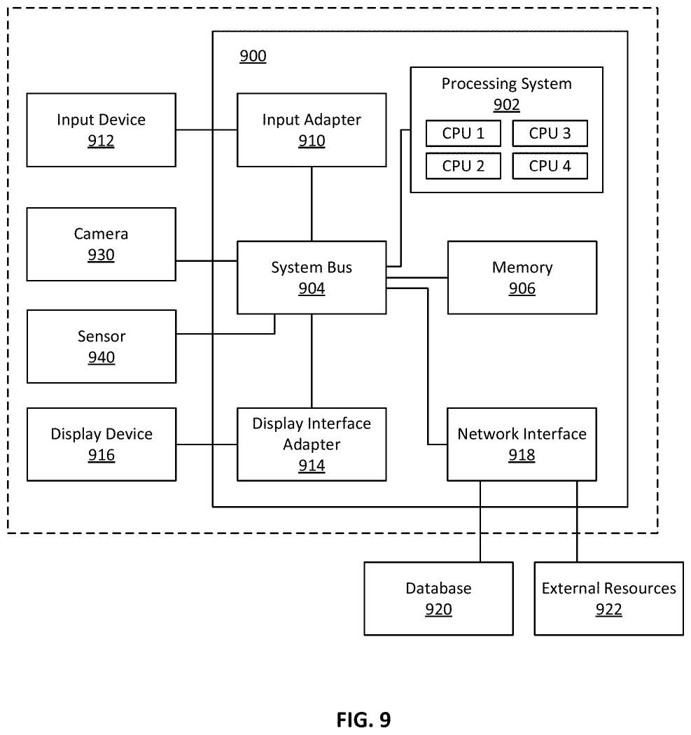

FIG. 9 shows a block diagram of an example computing device. In certain examples, the computing device 900 may be the client device or a device associated with a professional. In certain examples, the computing device 900 may correspond to the central processing system 40.

In certain examples, the computing device 900 includes one or more of the following: a processing system 902, which includes one or more hardware processors (e.g., central processing units or CPUs); one or more memory devices 906; one or more network interface devices 918; one or more display interfaces 914; and one or more user input adapters 910. Elements of computing device 900 may communicate with one another via system bus 904. Additionally, in some examples, the computing device 900 is connected to or includes one or more display devices 916, one or more user input devices 912, one or more cameras 930, one or more sensors 640, database 920, and/or external resources 922 (which may be another instance of computing device 900). As will be explained below, these elements (e.g., the processing system 902, memory devices 906, network interface devices 918, display interfaces 914, user input adapters 910, camera 930, sensor 940, display device 916) are hardware devices (for example, electronic circuits or combinations of circuits) that are configured to perform various different functions for the computing device 900.

In some examples, each or any of the processors (e.g., CPUs 1, 2, 3, or 4) of the processing system 902 is or includes, for example, a single- or multi-core processor, a microprocessor (e.g., which may be referred to as a central processing unit or CPU), a digital signal processor (DSP), a microprocessor in association with a DSP core, an Application Specific Integrated Circuit (ASIC), a Field Programmable Gate Array (FPGA) circuit, and/or a system-on-a-chip (SOC) (e.g., an integrated circuit that includes a CPU and other hardware components such as memory, networking interfaces, and the like). In certain examples, each or any of the processors may use an instruction set architecture such as x86 or Advanced RISC Machine (ARM).

In some examples, each or any of the memory devices 906 is or includes a random access memory (RAM) (such as a Dynamic RAM (DRAM) or Static RAM (SRAM)), a flash memory (based on, e.g., NAND or NOR technology), a hard disk, a magneto-optical medium, an optical medium, cache memory, a register (e.g., that holds instructions), or other type of device that performs the volatile or non-volatile storage of data and/or instructions (e.g., software that is executed on or by processors of the processing system 902). Memory devices 906 are examples of non-transitory computer-readable storage media.

In some examples, each or any of the network interface devices 918 includes one or more circuits (such as a baseband processor and/or a wired or wireless transceiver), and implements layer one, layer two, and/or higher layers for one or more wired communications technologies (such as Ethernet (IEEE 802.3)) and/or wireless communications technologies (such as Bluetooth, WiFi (IEEE 802.11), GSM, CDMA2000, UMTS, LTE, LTE-Advanced (LTE-A), and/or other short-range, mid-range, and/or long-range wireless communications technologies). Transceivers may comprise circuitry for a transmitter and a receiver. The transmitter and receiver may share a common housing and may share some or all of the circuitry in the housing to perform transmission and reception. In some examples, the transmitter and receiver of a transceiver may not share any common circuitry and/or may be in the same or separate housings.

In some examples, each or any of the display interfaces 914 is or includes one or more circuits that receive data from the processors of the processing system 902, generate (e.g., via a discrete GPU, an integrated GPU, a CPU executing graphical processing, or the like) corresponding image data based on the received data, and/or output (e.g., a High-Definition Multimedia Interface (HDMI), a DisplayPort Interface, a Video Graphics Array (VGA) interface, a Digital Video Interface (DVI), or the like), the generated image data to the display device 616, which displays the image data. Alternatively, or additionally, in some examples, each or any of the display interfaces 614 is or includes, for example, a video card, video adapter, or graphics processing unit (GPU).

In some examples, each or any of the user input adapters 910 is or includes one or more circuits that receive and process user input data from one or more user input devices 912 that are included in, attached to, or otherwise in communication with the computing device 900, and that output data based on the received input data to the processors 902. Alternatively, or additionally, in some examples each or any of the user input adapters 910 is or includes, for example, a PS/2 interface, a USB interface, a touchscreen controller, or the like; and/or the user input adapters 910 facilitates input from user input devices 912, which may include, for example, a keyboard, mouse, trackpad, touchscreen, voice input, etc. . . . . In certain examples, user input adapter 910 may be configured to process data from other types of input sources that are not from a user. For example, user input adapter 910 (e.g., an input adapter) may process data from one or more sensors (e.g., flow, pressure, temperature, or other types of sensors).

In some example, the sensor 940 may include one or more motion sensors, gyro sensors (e.g., multi-axis), and/or position sensors (e.g., a GPS sensor providing approximation of the location of the device).

In some examples, the display device 916 may be a Liquid Crystal Display (LCD) display, Light Emitting Diode (LED) display, or other type of display device. In examples where the display device 916 is a component of the computing device 900 (e.g., the computing device and the display device are included in a unified housing of, for example, a mobile or tablet device), the display device 916 may be a touchscreen display (e.g., using capacitive or resistive technology to sense a touch) or non-touchscreen display. In examples where the display device 916 is connected to the computing device 900 (e.g., is external to the computing device 900 and communicates with the computing device 900 via a wire and/or via wireless communication technology), the display device 916 is, for example, an external monitor, projector, television, display screen, etc. . . .

In various examples, the computing device 900 includes one, or two, or three, four, or more of each or any of the above-mentioned elements (e.g., the processing system 902, CPUs 1, 2, 3, or 4, memory devices 906, network interface devices 918, display interfaces 914, and user input adapters 910). In some examples, the computing device 900 includes one or more of: a processing system 902 that includes hardware processors (e.g., CPUs 1, 2, 3, and/or 4); a memory or storage system that includes the memory devices; and a network interface system that includes the network interface devices 918.

The computing device 900 may be arranged, in various examples, in many different ways. As just one example, the computing device 900 may be arranged such that the processors include: a multi (or single)-core processor; a first network interface device (which implements, for example, WiFi, Bluetooth, NFC, etc. . . . ); a second network interface device that implements one or more cellular communication technologies (e.g., 3G, 4G LTE, CDMA, etc. . . . ); memory or storage devices (e.g., RAM, flash memory, or a hard disk). The processor, the first network interface device, the second network interface device, and the memory devices may be integrated as part of the same SOC (e.g., one integrated circuit chip). As another example, the computing device 900 may be arranged such that: the processors include two, three, four, five, or more multi-core processors; the network interface devices 918 include a first network interface device that implements Ethernet and a second network interface device that implements WiFi and/or Bluetooth; and the memory devices 906 may include RAM and storage in the form of flash memory or hard disk.

Whenever it is described in this document that a software module or software process performs any action, the action may be performed by underlying hardware elements according to the instructions that comprise the software module.

The hardware configurations shown in FIG. 9 and described above are provided as examples, and the subject matter described herein may be utilized in conjunction with a variety of different hardware architectures and elements. For example: in the Figures in this document, individual functional/action blocks are shown; in various examples, the functions of those blocks may be implemented using (a) individual hardware circuits, (b) using an application specific integrated circuit (ASIC) specifically configured to perform the described functions/actions, (c) using one or more digital signal processors (DSPs) specifically configured to perform the described functions/actions, (d) using the hardware configuration described above with reference to FIG. 9, (e) via other hardware arrangements, architectures, and configurations, and/or via combinations of the technology described in (a) through (e).

The database 920 may be a database associated with a system managing the consumer services marketplace. The database 920 may store client information, project information, payment information, and/or professional information. The external resources 922 may correspond to the system managing the consumer services marketplace.

In certain examples, the techniques herein provide for improved consumer services marketplace, client user interface (e.g., displayed on client device), and/or professional user interface (displayed on device associated with professional). Such improvements may be based on providing for receiving and transmitting information related to home improvement and/or maintenance projects. In certain examples, the techniques herein allow for an improved user interface that can be displayed on portable devices (e.g., device with smaller screen) and/or reducing the number of inputs and/or information that needs be input and/or transmitted to and from certain devices.

The techniques discussed herein may also provide improvements over prior approaches. For example, prior approaches required for client and professional to be present at the project location in order to negotiate, perform and/or complete tasks related to the project. In contrast to such approaches, examples of the present technology provide a consumer services marketplace in which the client and professional do not have to be physically present at the same location. In addition, the present technology provide for an improved method of agreeing on a work proposal, tracking progress of the project, transferring payment, and/or sharing user experiences.

While the examples of the present technology have been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A system comprising:
memory;
a networking interface;
a processing system including at least one processor communicably coupled to the memory and the networking interface, wherein the processing system is configured to at least:
receive project information from a client device associated with a client, the project information including at least one image and a description of a project related to a physical location;
generate, based on the received project information, a project proposal;
transmit information about the project proposal to a plurality of devices each associated with a respective professional;
in response to transmitting the project proposal, receive bid information for the project proposal from the plurality of devices associated with the professionals;
transmit information for a plurality of bids for the project received from the plurality of devices associated with the professionals to the client device;
receive, from the client device, instructions to accept one of the plurality of bids;
receive, from the client device and/or the device associated with the professional whose bid is accepted, information about one or more milestones for the project; and
authorize transmission of payment for the project to the professional after receiving a confirmation of project completion from the client device and the device associated with the professional whose bid is accepted.

2. The system of claim 1, wherein the processing system is further configured to: receive, from the client device, payment information after receiving the instructions to accept the one of the plurality of bids.

3. The system of claim 1, wherein the processing system is further configured to: receive, from the device associated with the professional whose bid is accepted, a milestone confirmation indicating that one of the one or more milestones is completed, the milestone confirmation including at least one image of the physical location and a description of a completed portion of the project.

4. The system of claim 3, wherein the processing system is further configured to: transmit information about the milestone confirmation to the client device; and in response transmitting the information about the milestone confirmation to the client device, receive a client confirmation confirming completion of the one milestone.

5. The system of claim 4, wherein the processing system is further configured to: authorize transmission of a payment associated with the milestone to the professional whose bid is accepted after receiving the client confirmation.

6. The system of claim 4, wherein the processing system is further configured to: receive, from the device associated with the professional whose bid is accepted, location information of the device.

7. The system of claim 6, wherein the location information indicates location of the device associated with the professional whose bid is accepted at a time the at least one image of the physical location is captured by the device associated with the professional.

8. The system of claim 1, wherein the processing system is further configured to receive, from the client device, location information of the client device.

9. The system of claim 8, wherein the location information indicates location of the client device at a time the at least one image received from the client device is captured.

10. The system of claim 1, wherein the processing system is further configured to:
receive, from the device associated with the professional whose bid is accepted, information about a plurality of milestones for the project;
receive, from the client device, payment information for a bid amount after receiving the instructions to accept the one of the plurality of bids; and
associate a portion of the bid amount with each milestone of the plurality of milestones.

11. The system of claim 1, wherein the processing system is further configured to: after receiving the confirmation of project completion from the client device and the device associated with the professional, receive rating for the professional whose bid is accepted from the client device and receive rating for the client from the device associated with the professional.

12. The system of claim 1, wherein the processing system is further configured to:
for each of the plurality of professionals, determine a plurality of projects submitted by a plurality of clients that match each respective profile of the professional; and
transmit to each of the devices associated with the respective professions, the projects determined to match the respective professional.

13. A system comprising:
memory;
a networking interface;
a processing system including at least one processor communicably coupled to the memory and the networking interface, wherein the processing system is configured to at least:
receive project information from a client device associated with a client, the project information including at least one image and a description of a project related to a physical location;
generate, based on the received project information, a project proposal;
transmit information about the project proposal to a plurality of professional devices each associated with a respective professional;
in response to transmitting the project proposal, receive bid information for the project proposal from the plurality of devices associated with the professionals, the bid information including a cost for completing the project;
when the cost for completing the project is above a pre-set threshold, receiving information about at least one milestone from the corresponding professional device;
transmit information for a plurality of bids for the project received from the plurality of devices associated with the professionals to the client device;
receive, from the client device, instructions to accept one of the plurality of bids;
after receiving the instructions to accept the one of the plurality of bids, receive, from the client device, payment information for the cost of completing the project for the accepted bid; and
when the accepted bid includes at least one milestone, (1) authorize transmission of a portion of the cost of completing the project to the professional after receiving a confirmation for completing the at least one milestone from the client device and the professional device associated with the professional whose bid is accepted and (2) authorize transmission of another portion of the cost of completing the project to the professional after receiving a confirmation for completing the project from the client device and the professional device associated with the professional whose bid is accepted.

14. The system of claim 13, wherein receiving the confirmation for completing the at least one milestone from the professional device includes receiving at least one image of the physical location and a description of a completed portion of the project.

15. The system of claim 14, wherein the processing system is further configured to: transmit information about the at least one milestone confirmation to the client device; and in response transmitting the information about the milestone confirmation to the client device, receive a client confirmation confirming completion of the at least one milestone.

16. The system of claim 14, wherein the processing system is further configured to: receive, from the professional device associated with the professional whose bid is accepted, location information of the device indicating location of the professional device associated with the professional whose bid is accepted at a time the at least one image of the physical location is captured by the professional device associated with the professional.

17. The system of claim 13, wherein the processing system is further configured to receive, from the client device, location information of the client device.

18. The system of claim 17, wherein the location information indicates location of the client device at a time the at least one image received from the client device is captured.

19. The system of claim 13, wherein the processing system is further configured to: after receiving the confirmation of project completion from the client device and the device associated with the professional, receive rating for the professional whose bid is accepted from the client device and receive rating for the client from the device associated with the professional.

20. A non-transitory storage medium storing computer-readable instructions executable by a computer including at least one processor, the instructions, when executed by the computer, cause the computer to at least:
receive project information from a client device associated with a client, the project information including at least one image and a description of a project related to a physical location;
generate, based on the received project information, a project proposal;
transmit information about the project proposal to a plurality of devices each associated with a respective professional;
in response to transmitting the project proposal, receive bid information for the project proposal from the plurality of devices associated with the professionals;
transmit information for a plurality of bids for the project received from the plurality of devices associated with the professionals to the client device;
receive, from the client device, instructions to accept one of the plurality of bids;
receive, from the client device and/or the device associated with the professional whose bid is accepted, information about one or more milestones for the project; and
authorize transmission of payment for the project to the professional after receiving a confirmation of project completion from the client device and the device associated with the professional whose bid is accepted.
